(19) United States
(12) Patent Application Publication
(10) Pub. No.: US 2026/0351471 A1
(43) Pub. Date: Nov. 5, 2026

(54) ONE-PIECE BOBBIN STRUCTURE, BOBBIN STRUCTURE ARRANGEMENT AND INTEGRATED MAGNETIC ASSEMBLY

(71) Applicant: Delta Electronics (Thailand) Public Co., Ltd., Samutprak (TH)

(72) Inventor: Hugues NJIENDE, Soest (DE)

(21) Appl. No.: 19/557,072

(22) Filed: Mar. 4, 2026

(30) Foreign Application Priority Data
Mar. 6, 2025 (EP) 25162182.7

(51) Int. Cl. H01F 27/32; H01F 27/26

(52) U.S. Cl. CPC H01F 27/325; H01F 27/266

(57) ABSTRACT

A one-piece bobbin structure for an integrated magnetic assembly comprises: two ending sections; N winding sections, with N being a natural number equal to two or three, wherein the N winding sections are consecutively arranged along a principal direction of extent between the two ending sections; and N-1 separation sections. Any two neighboring winding sections are separated from each other by a corresponding separation section, and each separation section is embodied to at least partly enclose a respective reception space. The N-1 separation sections are configured for receiving a set of first soft-magnetic core elements in the N-1 reception spaces, and the N-1 separation sections are embodied such that the first soft-magnetic core elements are insertable into the N-1 reception spaces by displacing themselves only along a first direction, which is distinct from the principal direction of extent.

### CROSS-REFERENCE TO RELATED APPLICATIONS

This application claims priority to European Patent Application No. 25162182.7, filed on Mar. 6, 2025, which is hereby incorporated by reference in its entirety.

### TECHNICAL FIELD

The application relates to a one-piece bobbin structure for an integrated magnetic assembly, to a bobbin structure arrangement for an integrated magnetic assembly and to an integrated magnetic assembly.

### BACKGROUND

For the assembly of integrated magnetic assemblies comprising multiple windings, in the prior art typically such windings are wound on separate bobbins. The use of separate bobbins, however, increases number of parts to be assembled and makes the assembly process as well as the automated production of such integrated magnetic assemblies difficult. The use of separate bobbins further complicates the winding process during assembly, specifically in case windings that are wound around separate bobbins need to be electrically connected without a winding interruption.

### SUMMARY

In a first aspect, the application relates to a one-piece bobbin structure for an integrated magnetic assembly, the one-piece bobbin structure includes two ending sections, N winding sections and N-1 separation sections. The two ending sections include a first ending section and a second ending section. The N winding sections are consecutively arranged along a principal direction of extent between the first ending section and the second ending section, N being a natural number equal to two or three. Any two neighboring winding sections of the N winding sections are separated from each other by a corresponding separation section of the N-1 separation sections, and each separation section of the N-1 separation sections is embodied such that it at least partly encloses a respective reception space from three sides. The N-1 separation sections are configured for receiving a set of first soft-magnetic core elements in the N-1 reception spaces, and the N-1 separation sections are embodied such that the first soft-magnetic core elements are insertable into the N-1 reception spaces by displacing the first soft-magnetic core elements along a first direction, which is distinct from the principal direction of extent.

The one-piece bobbin structure is embodied such that a through-hole passes from the first ending section to the second ending section along the principal direction of extent, with N segments of the through-hole being enclosed by the N winding sections, with the through-hole passing through the N-1 reception spaces, and with the principal direction of extent passing through the through-hole; and a set of second soft-magnetic core elements are insertable into the through-hole from the first ending section towards the second ending section or from the second ending section towards the first ending section, by displacing the second soft-magnetic core elements along the principal direction of extent.

In an embodiment, each of the N winding sections is embodied as a hollow cylinder whose respective axis is parallel to the principal direction of extent, with each hollow cylinder surrounding a respective hollow interior, and with the N hollow interiors being the N segments of the through-hole.

In an embodiment, each hollow cylinder has a rectangular base or a circular base.

In an embodiment, each separation section of the N-1 separation sections includes two spacing plates that are parallel to one another, oriented in an orthogonal manner with respect to the principal direction of extent, and are spaced apart from one another along the principal direction of extent, and each of the two spacing plates includes a hole.

In an embodiment, the one-piece bobbin structure is embodied such that the through-hole passes through the two middle holes in the two spacing plates of each separation section, and each separation section separates two neighboring winding sections, a first spacing plate of the two spacing plates is arranged at a first end of a first winding section of the two neighboring winding sections and a second spacing plate of the two spacing plates is arranged at a second end of a second winding section of the two neighboring winding sections, with the first end of the first winding section facing the second end of the second winding section. Each separation section further includes a third bottom plate which is set on a plane orthogonal to the first direction and connects the two spacing plates between corresponding edges of the two spacing plates. For each separation section, the two spacing plates and the third bottom plate at least partly enclose the respective reception space, where the first direction is orthogonal to the principal direction of extent, and the plane does not intersect with the principal direction of extent.

In an embodiment, each ending section of the two ending sections includes an ending plate that is orthogonal to the principal direction of extent and which ending plate includes an ending hole, where the one-piece bobbin structure is embodied such that the through-hole passes through the two ending holes of the two ending sections.

In an embodiment, the two ending plates and all spacing plates of the N-1separation sections have equal dimensions from a perspective of the principal direction of extent, and the two ending holes of the two ending plates and all middle holes of the N-1 separation sections are aligned with each other.

In an embodiment, the first ending section includes a first part of a first snap-fitting mechanism, which is configured to interact with a first complementary part of the first snap-fitting mechanism to provide snap-fitting, and the second ending section includes a second part of a second snap-fitting mechanism, which is configured to interact with a second complementary part of the second snap-fitting mechanism to provide snap-fitting.

In a second aspect, the application relates to a bobbin structure arrangement including M one-piece bobbin structures according to the above-mentioned first aspect, with M being a natural number equal to or greater than two, where all of the M one-piece bobbin structures have a same structure, and the respective principal directions are parallel to one another. For any two neighboring one-piece bobbin structures of the M one-piece bobbin structures, the first ending section of a first one-piece bobbin structure of the respective two neighboring one-piece bobbin structures includes a first part of a first snap-fitting mechanism, and the first ending section of a second one-piece bobbin structure of the respective two neighboring one-piece bobbin structures includes a first complementary part of the first snap-fitting mechanism. Also, the second ending section of the first one-piece bobbin structure of the respective two neighboring one-piece bobbin structures includes second a part of a second snap-fitting mechanism, and the second ending section of the second one-piece bobbin structure of the respective two neighboring one-piece bobbin structures includes a second complementary part of the second snap-fitting mechanism. The respective two neighboring one-piece bobbin structures are snap-fitted to one another through interaction between the first part of the first snap-fitting mechanism and the first complementary part of the first snap-fitting mechanism and through interaction between the second part of the second snap-fitting mechanism and the second complementary part of the second snap-fitting mechanism.

In an embodiment, the N-1 separation sections of any one-piece bobbin structure of the M one-piece bobbin structures are bijectively related to the N-1 separation sections of any other one-piece bobbin structure of the M one-piece bobbin structures, where bijectively related separation sections of the M one-piece bobbin structures are arranged at substantially same positions with respect to the M parallel principal directions of extent, and where the bobbin structure arrangement at least partly encloses N-1 joint reception spaces, with each joint reception space of the N-1 joint reception spaces including the M reception spaces which are at least partly enclosed by bijectively related separation sections.

In an embodiment, N is equal to two and the integrated magnetic assembly has a choke winding, a primary transformer winding and a secondary transformer winding, with the choke winding being wound around a first winding section of the two winding sections and with the primary transformer winding and the secondary transformer winding being wound around a second winding section of the two winding sections. The set of first soft-magnetic core elements includes one I-core, the I-core having one yoke, and the set of second soft-magnetic core elements includes two E-cores, with each of the two E-cores having a yoke and three legs and with the three legs being parallel to one another, being arranged on one side of the yoke and being orthogonal to the yoke. The two E-cores are arranged such that a central leg of each E-core is arranged in a corresponding segment of the two segments of the through-hole, and the I-core and each of the two E-cores are dimensioned such that for each segment of the two segments a closed-loop magnetic path exists through the following magnetic core components: (i) the central leg in the respective segment, (ii) the I-core, (iii) an outer leg of the two outer legs of the E-core whose central leg is arranged in the respective segment, and (iv) the yoke of the E-core whose central leg is arranged in the respective segment.

In an embodiment, N is equal to two and the integrated magnetic assembly has a first choke winding, a primary transformer winding and a secondary transformer winding. The first choke winding is wound around a first winding section of the two winding sections, and the primary transformer winding and the secondary transformer winding are wound around a second winding section of the two winding sections. The set of first soft-magnetic core elements includes one U-core having a yoke and two legs, and the two legs are parallel to each other, arranged on one side of the yoke and orthogonal to the yoke, where the yoke of the U-core is arranged in the one reception space of the one-piece bobbin structure.

The set of second soft-magnetic core elements includes two E-cores. Each of the two E-cores has a yoke and three legs, and the three legs are parallel to one another, arranged on one side of the yoke and orthogonal to the yoke. The two E-cores are arranged such that a central leg of each E-core is arranged in a corresponding segment of the two segments of the through-hole, and the two outer legs of a first E-core of the two E-cores abut the two outer legs of the U-core.

The set of second soft-magnetic core elements includes two E-cores. Each of the two E-cores has a yoke and three legs, and the three legs are parallel to one another, arranged on one side of the yoke and orthogonal to the yoke. The two E-cores are arranged such that a central leg of each E-core is arranged in a corresponding segment of the two segments of the through-hole, and the two outer legs of a first E-core of the two E-cores abut the two outer legs of the U-core.

In an embodiment, N is equal to three and the integrated magnetic assembly has a primary choke winding, a primary transformer winding, a secondary transformer winding and a secondary choke winding. The primary choke winding is wound around a first winding section of the three winding sections, the primary transformer winding and the secondary transformer winding are wound around a second winding section of the three winding sections, and the secondary choke winding is wound around a third winding section of the three winding sections. The set of first soft-magnetic core elements includes two U-cores. each U-core has one yoke and two legs, and the two legs are parallel to one another, arranged on one side of the yoke and orthogonal to the yoke. The two yokes of the two U-cores are respectively arranged in the two reception spaces, and the two legs of a first U-core of the two U-cores respectively abut the two legs of a second U-core of the two U-cores. The set of second soft-magnetic core elements includes two E-cores and a transformer core. each of the two E-cores has a yoke and three legs, and the three legs are parallel to one another, arranged on one side of the yoke and orthogonal to the yoke. The two E-cores are arranged such that a central leg of each E-core is arranged in a corresponding segment enclosed by the first winding section or the third winding section, and the transformer core is arranged in the segment enclosed by the second winding section.

In a fourth aspect, the application relates to another integrated magnetic assembly, which includes the bobbin structure arrangement according to the above-mentioned second aspect, the set of first soft-magnetic core elements having N-1 soft-magnetic core elements, the set of second soft-magnetic core elements, and at least M*N windings. Each of the first soft-magnetic core elements is arranged in a corresponding joint reception space of the N-1 joint reception spaces of the bobbin structure arrangement. In each segment of the M*N segments of the M through-holes of the bobbin structure arrangement, at least one of the second soft-magnetic core elements is arranged, and the at least M*N windings are wound around the M*N winding sections of the bobbin structure arrangement. The N-1 first soft-magnetic core elements and the second soft-magnetic core elements are arranged such that for each segment of the M*N segments, a respective closed-loop magnetic path exists that passes at least through the at least one of the second soft-magnetic core elements that is arranged in the respective segment, and through at least one of the N-1 soft-magnetic first core elements.

In an embodiment, N is equal to two and M is equal to two. The integrated magnetic assembly has a first choke winding, a first primary transformer winding, a first secondary transformer winding, a second choke winding, a second primary transformer winding and a second secondary transformer winding. The first choke winding is wound around one winding section of the two winding sections of a first one-piece bobbin structure of the bobbin structure arrangement, and the first primary transformer winding and the first secondary transformer winding are wound around the other winding section of the two winding sections of the first one-piece bobbin structure. The second choke winding is wound around one winding section of the two winding sections of a second one-piece bobbin structure of the bobbin structure arrangement, and the second primary transformer winding and the second secondary transformer winding are wound around the other winding section of the two winding sections of the second one-piece bobbin structure.

The set of first soft-magnetic core elements includes one I-core, the I-core has one yoke and is arranged in the one joint reception space. The set of second soft-magnetic core elements includes two U-cores, each of the two U-cores has a yoke and two legs, and the two legs are parallel to each other, arranged on one side of the yoke and orthogonal to the yoke. The two U-cores are arranged such that the two legs of a first U-core of the two U-cores are arranged in the two segments enclosed by the two winding sections around which the first choke winding and respectively the second choke winding are wound. The two legs of a second U-core of the two U-cores are arranged in the two segments enclosed by the two winding sections around which the first primary transformer winding and the first secondary transformer winding and respectively the second primary transformer winding and the second secondary transformer winding are wound. The two U-cores and the I-core are dimensioned such that (i) a first closed-loop magnetic path exists through the yoke of the first U-core, the two legs of the first U-core and the I-core, and such that (ii) a second closed-loop magnetic path exists through the yoke of the second U-core, the two legs of the second U-core and the I-core.

In an embodiment, N is equal to two and M is equal to three. The integrated magnetic assembly has a first choke winding, a first primary transformer winding, a first secondary transformer winding, a second choke winding, a second primary transformer winding and a second secondary transformer winding, a third choke winding, a third primary transformer winding and a third secondary transformer winding. The first choke winding is wound around one winding section of the two winding sections of a first one-piece bobbin structure of the bobbin structure arrangement, and the first primary transformer winding and the first secondary transformer winding are wound around the other winding section of the two winding sections of the first one-piece bobbin structure. The second choke winding is wound around one winding section of the two winding sections of a second one-piece bobbin structure of the bobbin structure arrangement, and the second primary transformer winding and the second secondary transformer winding are wound around the other winding section of the two winding sections of the second one-piece bobbin structure. The third choke winding is wound around one winding section of the two winding sections of a third one-piece bobbin structure of the bobbin structure arrangement, and the third primary transformer winding and the third secondary transformer winding are wound around the other winding section of the two winding sections of the third one-piece bobbin structure.

The set of first soft-magnetic core elements includes one I-core, which has one yoke and is arranged in the one joint reception space. The set of second soft-magnetic core elements includes two E-cores, each of the two E-cores has a yoke and three legs, and the three legs are parallel to one another, arranged on one side of the yoke and orthogonal to the yoke. The two E-cores are arranged such that the three legs of a first E-core of the two E-cores are arranged in the three segments enclosed by the three winding sections around which the first choke winding, the second choke winding and respectively the third choke winding are wound. And the three legs of a second E-core of the two E-cores are arranged in the three segments enclosed by the three winding sections around which the first primary transformer winding and the first secondary transformer winding, the second primary transformer winding and the second secondary transformer winding and respectively the third primary transformer winding and the third secondary transformer winding are wound.

In an embodiment, N is equal to two and M is equal to two. The integrated magnetic assembly has a first choke winding, a first primary transformer winding, a first secondary transformer winding, a second choke winding, a second primary transformer winding and a second secondary transformer winding. The first choke winding is wound around one winding section of the two winding sections of a first one-piece bobbin structure of the bobbin structure arrangement, and the first primary transformer winding and the first secondary transformer winding are wound around the other winding section of the two winding sections of the first one-piece bobbin structure. The second choke winding is wound around one winding section of the two winding sections of a second one-piece bobbin structure of the bobbin structure arrangement, and the second primary transformer winding and the second secondary transformer winding are wound around the other winding section of the two winding sections of the second one-piece bobbin structure. The set of first soft-magnetic core elements includes one I-core, which has one yoke and is arranged in the one joint reception space. And the set of second soft-magnetic core elements includes two E-cores, in which each of the two E-cores has a yoke and three legs, and the three legs are parallel to each other, arranged on one side of the yoke and orthogonal to the yoke. The two E-cores are arranged such that the two outer legs of a first E-core of the two E-cores are arranged in the two segments enclosed by the two winding sections around which the first choke winding and respectively the second choke winding are wound. The two outer legs of a second E-core of the two E-cores are arranged in the two segments enclosed by the two winding sections around which the first primary transformer winding and the first secondary transformer winding and respectively the second primary transformer winding and the second secondary transformer winding are wound. The two E-cores and the I-core are dimensioned such that (i) a first closed-loop magnetic path exists through the yoke of the first E-core, an outer leg of the first E-core, the I-core and a central leg of the first E-core, and such that (ii) a second closed-loop magnetic path exists through the yoke of the second E-core, an outer leg of the second E-core, the I-core and a central leg of the second E-core.

In an embodiment, N is equal to two and M is equal to three. The integrated magnetic assembly has a first choke winding, a first primary transformer winding, a first secondary transformer winding, a second choke winding, a second primary transformer winding and a second secondary transformer winding, a third choke winding, a third primary transformer winding and a third secondary transformer winding. The first choke winding is wound around one winding section of the two winding sections of a first one-piece bobbin structure of the bobbin structure arrangement, and the first primary transformer winding and the first secondary transformer winding are wound around the other winding section of the two winding sections of the first one-piece bobbin structure. The second choke winding is wound around one winding section of the two winding sections of a second one-piece bobbin structure of the bobbin structure arrangement, and the second primary transformer winding and the second secondary transformer winding are wound around the other winding section of the two winding sections of the second one-piece bobbin structure. The third choke winding is wound around one winding section of the two winding sections of a third one-piece bobbin structure of the bobbin structure arrangement, and the third primary transformer winding and the third secondary transformer winding are wound around the other winding section of the two winding sections of the third one-piece bobbin structure. The set of first soft-magnetic core elements includes one I-core which has one yoke and is arranged in the one joint reception space. The set of second soft-magnetic core elements includes two W-cores, and each of the two W-cores has a yoke and five legs, which areg parallel to one another, arranged on one side of the yoke and orthogonal to the yoke. The two W-cores are arranged such that two outer legs and one central leg of a first W-core of the two W-cores are arranged in the three segments enclosed by the three winding sections around which the first choke winding, the second choke winding and respectively the third choke winding are wound. And two outer legs and one central leg of a second W-core of the two W-cores are arranged in the three segments enclosed by the three winding sections around which the first primary transformer winding and the first secondary transformer winding respectively the second primary transformer winding and the second secondary transformer winding and respectively the third primary transformer winding and the third secondary transformer winding are wound.

In an embodiment, N is equal to three and M is equal to two. The integrated magnetic assembly has a first primary choke winding, a first primary transformer winding, a first secondary transformer winding, a first secondary choke winding, a second primary choke winding, a second primary transformer winding, a second secondary transformer winding and a second secondary choke winding. The first primary choke winding is wound around a first winding section of the three winding sections of a first one-piece bobbin structure of the bobbin structure arrangement, the first primary transformer winding and the first secondary transformer winding are wound around a second winding section of the three winding sections of the first one-piece bobbin structure, and the first secondary choke winding is wound around a third winding section of the three winding sections of the first one-piece bobbin structure. The second primary choke winding is wound around a first winding section of the three winding sections of a second one-piece bobbin structure of the bobbin structure arrangement, the second primary transformer winding and the second secondary transformer winding are wound around a second winding section of the three winding sections of the second one-piece bobbin structure, and the second secondary choke winding is wound around a third winding section of the three winding sections of the second one-piece bobbin structure. The set of first soft-magnetic core elements includes two I-cores, each I-core has one yoke and is arranged in the two joint reception spaces. The set of second soft-magnetic core elements includes two U-cores and two transformer cores, each of the two U-cores having a yoke and two legs, and the two legs are parallel to each other, arranged on one side of the yoke and orthogonal to the yoke. The two U-cores are arranged such that the two legs of a first U-core of the two U-cores are arranged in the two segments enclosed by the two winding sections around which the first primary choke winding and respectively the second primary choke winding are wound. The two legs of a second U-core of the two U-cores are arranged in the two segments enclosed by the two winding sections around which the first secondary choke winding respectively the second secondary choke winding are wound. And the two transformer cores are arranged in the two segments enclosed by the two winding sections around which the first primary transformer winding and the first secondary transformer winding, and respectively the second primary transformer winding and the second secondary transformer winding are wound.

### BRIEF DESCRIPTION OF THE DRAWINGS

FIG. 1 shows an embodiment of a one-piece bobbin structure.

FIGS. 2 to 4 show embodiments of a one-piece bobbin structure and bobbin structure arrangements assembled from one-piece bobbin structures.

FIGS. 5 to 9 show different views of embodiments of integrated magnetic assemblies.

FIGS. 10 to 19 show schematic sectional views through windings and soft-magnetic core elements of integrated magnetic assemblies.

### DESCRIPTION OF EMBODIMENTS

The object of the application is to provide a one-piece bobbin structure that mitigates at least some of the disadvantages of prior-art solutions.

In a first aspect, the application relates to a one-piece bobbin structure for an integrated magnetic assembly. The one-piece bobbin structure comprises: two ending sections comprising a first ending section and a second ending section; N winding sections consecutively arranged along a principal direction of extent between a first ending section and a second ending section, N being a natural number equal to two or three; and N-1 separation sections, wherein any two neighboring winding sections of the N winding sections are separated from each other by a corresponding separation section of the N-1 separation sections, wherein each separation section of the N-1 separation sections is embodied such that it at least partly encloses a respective reception space from three sides, wherein the N-1 separation sections are configured for receiving a set of first soft-magnetic core elements in the N-1 reception spaces, and wherein the N-1 separation sections are embodied such that the first soft-magnetic core elements are insertable into the N-1 reception spaces by displacing the first soft-magnetic core elements along a first direction, which is distinct from the principal direction of extent.

The one-piece bobbin structure is embodied such that a through-hole passes from the first ending section to the second ending section along the principal direction of extent, with N segments of the through-hole being enclosed by the N winding sections, with the through-hole passing through the N-1 reception spaces, and with the principal direction of extent passing through the through-hole. The one-piece bobbin structure is further embodied such that second soft-magnetic core elements are insertable into the through-hole (i) from the first ending section towards the second ending section or (ii) from the second ending section towards the first ending section, by displacing the second soft-magnetic core elements along the principal direction of extent.

The above-mentioned principal direction of extent denotes a two-dimensional curve in three-dimensional space, or a straight line in three-dimensional space. Unless explicitly mentioned, this two-dimensional curve is not associated with a direction. An object that is displaced along the principal direction of extent may therefore be displaced along both directions of the two-dimensional curve. In contrast, the term direction on its own is associated to a two-dimensional curve in three-dimensional space, or a straight line in three-dimensional space, with a specified orientation.

The one-piece bobbin structure is designed for an integrated magnetic assembly. An integrated magnetic assembly typically comprises a plurality of soft-magnetic core elements and a plurality of windings, for example choke windings as well as primary and secondary transformer windings. Typically, the plurality of soft-magnetic core elements are arranged such that closed-loop magnetic paths exist through the arranged plurality of soft-magnetic core elements. Integrated magnetic assemblies may be used in high-power applications, for example as part of DC-to-DC power converters. Windings may be formed using enameled wire, for example.

Soft-magnetic materials that may be used for soft-magnetic core elements are materials that can be easily magnetized by an external magnetic field, the magnetization in soft-magnetic materials producing a much stronger magnetic flux density in the soft-magnetic material than the magnetic flux density of the external magnetic field in air. Compared to hard-magnetic materials, soft-magnetic materials have small hysteresis losses. As soft-magnetic materials for soft-magnetic core elements, for example ferrites, in particular manganese-zinc ferrites or nickel-zinc ferrites, or other materials with high magnetic permeability may be used. Cores known in the prior art as ferrite cores, amorphous cores, nanocrystalline cores or pressed-powder cores may be used as soft-magnetic core elements, for example.

The one-piece bobbin structure is formed in an integral manner, such that a disassembly of the one-piece bobbin structure is non-reversible, i.e. permanent. The one-piece bobbin structure is formed such that around its N winding sections, at least N different windings may be arranged. Accordingly, a single one-piece bobbin structure may provide a structure around which at least N windings may be wound, in turn advantageously simplifying assembly of an integrated magnetic assembly requiring a plurality of different windings such a choke windings or transformer windings.

The one-piece bobbin structure may be formed of an electrically insulating material that is further diamagnetic or paramagnetic. The one-piece bobbin structure may therefore be made such that electrical shorting between turns of windings wound around winding section(s) of the one-piece bobbin structure through the one-piece bobbin structure are prevented. A diamagnetic or paramagnetic material may further interact only weakly with a magnetic field that may be produced by winding(s) wound around the winding section(s) of the one-piece bobbin structure. The one-piece bobbin structure may be made from a plastic material.

The N winding sections of a one-piece bobbin structure are consecutively arranged along a principal direction of extent between two ending sections of the one-piece bobbin structure. Due to this consecutive arrangement of the N winding sections, each winding section of the N winding sections therefore either comprises one or two neighboring winding sections. Any two neighboring winding sections are separated by a separation section of the one-piece bobbin structure. Accordingly, the one-piece bobbin structure comprises N-1 separation sections in total. As all winding sections have a defined position within the one-piece bobbin structure, advantageously a process for creating windings around the N winding sections is simplified.

Each separation section at least partly encloses a respective reception space from three sides. Accordingly, the one-piece bobbin structure provides N-1 reception spaces. The N-1 reception spaces are configured for receiving a set of first soft-magnetic core elements, in which the set of first soft-magnetic core elements may comprise one, two, three, etc. soft-magnetic core elements, in particular N-1 soft-magnetic core elements. Depending on the shape and size of the first soft-magnetic core elements, some or all of these soft-magnetic core elements may not be fully insertable into the N-1 reception spaces, i.e. only parts of these soft-magnetic core elements may be inserted into the N-1 reception spaces while other parts of these soft-magnetic core elements may remain outside the N-1 reception spaces. By inserting soft-magnetic core elements into the N-1 reception spaces, between any pair of winding sections of the N winding sections, at least some of the inserted soft-magnetic core elements may be arranged.

The one-piece bobbin structure further comprises a through-hole that passes from the first ending section to the second ending section. The principal direction of extent of the one-piece bobbin structure passes through the through-hole. As in N segments of the through-hole, the through-hole is enclosed by the N winding sections, after inserting a set of second soft-magnetic core elements into the through-hole, the N winding sections enclose at least parts of the inserted second soft-magnetic core elements. The through-hole further passes through the N-1 reception spaces. The second soft-magnetic core elements may comprise one, two, three, etc. soft-magnetic core elements, in particular N soft-magnetic core elements.

As the through-hole passes through the N-1 reception spaces, the set of first soft-magnetic core elements that may be inserted into the N-1 reception spaces may potentially interfere with the insertion of the set of second soft-magnetic core elements into the through-hole and vice versa, which the set of second soft-magnetic core elements may be inserted into the through-hole by displacing the respective soft-magnetic core elements substantially only along the principal direction of extent.

The N-1 separation sections are designed such that the set of first soft-magnetic core elements are insertable into the N-1 reception spaces by displacing these soft-magnetic core elements substantially only along a first direction that is distinct from the principal direction of extent along which the set of second soft-magnetic core elements are insertable into the through-hole. In an implementation, the N-1 separation sections may be designed such that the first direction is orthogonal to the principal direction of extent.

As the one-piece bobbin structure is designed such that the set of first soft-magnetic core elements and the set of second soft-magnetic core elements may be inserted into the N-1 reception spaces and the through-hole by being displaced along different directions, interference during insertion advantageously may be mitigated. For example, first N second soft-magnetic core elements of the may be inserted—for some of the N soft-magnetic core elements, potentially only parts thereof—into the N segments of the through-hole such that after the insertion, no soft-magnetic core elements are arranged in the N-1 reception spaces; thereafter, the set of first soft-magnetic core elements may be inserted into the N-1 reception spaces.

It is noted that, while the one-piece bobbin structure is embodied such that the set of first soft-magnetic core elements are insertable into the N-1 reception spaces by being displaced substantially only along the first direction, other insertion directions are not necessarily prohibited. Besides the first direction, in principle other insertion directions may be feasible as well and allowed by the one-piece bobbin structure. The one-piece bobbin structure is embodied such, however, that at least insertions along substantially only the first direction are possible into the N-1 reception spaces. A similar observation applies to the through-hole and the principal direction of extent. The one-piece bobbin structure may also be embodied such that insertion into the N-1 reception spaces is only possible along the first direction and/or that insertion into the through-hole is only possible along the principal direction of extent.

In an embodiment of the one-piece bobbin structure according to the application, each of the N winding sections is embodied as a hollow cylinder whose respective axis is parallel to the principal direction of extent, with each hollow cylinder surrounding a respective hollow interior, and with the N hollow interiors being part of the through-hole.

The N hollow interiors of the N winding sections may correspond to the N segments of the through-hole. In an implementation, the axis of each hollow cylinder is orthogonal to the two-dimensional plane in which the base of the respective hollow cylinder lies.

In a further embodiment of the one-piece bobbin structure according to the application, each hollow cylinder has a rectangular base or a circular base.

More precisely, the base of each hollow cylinder substantially may correspond to an intersection of the following two sets that both lie in a same two-dimensional plane: 1) the outside space outside an inner rectangle or an inner circle; and 2) the interior space within an outer rectangle or an outer circle, with the outer rectangle or the outer circle fully containing the inner rectangle or the inner circle. In an implementation, the inner rectangle or the inner circle may be symmetrically positioned within the outer rectangle or the outer circle. In case of a rectangular base, the base of each hollow cylinder may therefore also be described as an annular rectangular base; in case of a circular base, the base of each hollow cylinder may also be described as an annular circular base. The interior space of the inner rectangle or the inner circle thereby mathematically creates, after displacement along the axis of the respective hollow cylinder, the hollow interior of the respective hollow cylinder. In case of such an annular rectangular base or annular circular base, at least the parts of the second soft-magnetic core elements that may be inserted into the N hollow interiors of the through-hole may be shaped as rectangular cuboids or as right circular cylinders, which rectangular cuboids or right circular cylinders may be matched to the dimensions of the N hollow interiors of the one-piece bobbin structure.

In a further embodiment of the one-piece bobbin structure according to the application, each separation section of the N-1 separation sections comprises two spacing plates that are parallel to one another, oriented in an orthogonal manner with respect to the principal direction of extent, and are spaced apart from one another along the principal direction of extent, and each of the spacing plates comprises a middle hole. Also the one-piece bobbin structure is embodied such that the through-hole passes through the two middle holes in the two spacing plates of each separation section, and each separation sectio separates two neighboring winding sections, a first spacing plate of the two spacing plates is arranged at a first end of a first winding section of the two neighboring winding sections and a second spacing plate of the two spacing plates is arranged at a second end of a second winding section of the two neighboring winding sections, with the first end of the first winding section facing the second end of the second winding section. The first direction is orthogonal to the principal direction of extent and each separation section further comprises a third bottom plate, which is set on a plane orthogonal to the first direction and connects the two spacing plates between corresponding edges of the two spacing plates, and wherein for each separation section, the two spacing plates and the third bottom plate at least partly enclose the respective reception space, where the first direction is orthogonal to the principal direction of extent, and the plane does not intersect with the principal direction of extent.

The first spacing plate, the second spacing plate and the third bottom plate are arranged such that each of these plates and combinations among them restrict insertion directions of the set of first soft-magnetic core into each reception space. The first spacing plate and the second spacing plate for example may prevent insertion directions that are not orthogonal to the principal direction of extent, while the third bottom plate through its arrangement with respect to the first and second spacing plates may prevent an insertion direction that is opposite to the first direction.

To insert a soft-magnetic core element into a specific reception space, the soft-magnetic core element may therefore be displaced towards the third bottom plate, of which third bottom plate defines a boundary of the specific reception space, first having to pass the two spacing plates which also define boundaries of the specific reception space-before coming into contact with the third bottom plate. Advantageously, the first spacing plate, the second spacing plate and the third bottom plate may help positioning inserted soft-magnetic core elements at defined positions with respect to the neighboring winding sections of the specified reception space. Functionally, all three plates may be viewed as support plates for inserted soft-magnetic core elements. Through the two parallel plates, the insertion of soft-magnetic core elements is advantageously guided.

In a further embodiment of the one-piece bobbin structure according to the application, each ending section of the two ending sections comprises an ending plate that is oriented in an orthogonal manner with respect to the principal direction of extent and which ending plate comprises an ending hole. The one-piece bobbin structure is embodied such that the through-hole passes through the two ending holes of the two ending sections.

The respective sides of the two ending plates that face away from the one-piece bobbin structure may function as support plates on which (parts of) soft-magnetic core elements may be positioned.

In the space between (i) the ending plate of the first ending section and (ii) a neighboring plate of the two spacing plates, i.e. the first spacing plate and the second spacing plate, of the separation structure of the N-1 separation structures that is closest to the first ending section, windings may be arranged, of which windings may advantageously be at least partly shielded by the ending plate of the first ending section and the respective neighboring plate. Of the two spacing plates of the separation structure that is closest to the first ending section, the neighboring plate is the plate that is closer to the ending plate of the first ending section as measured along the principal direction of extent.

Similarly, in the space between (i) the ending plate of the second ending section and (ii) a neighboring plate of the two spacing plates, i.e. the first spacing plate and the second spacing plate, of the separation structure of the N-1 separation structures that is closest to the second ending section, windings may be arranged, of which windings may advantageously be at least partly shielded by the ending plate of the second ending section and the respective neighboring plate. Of the two spacing plates of the separation structure that is closest to the second ending section, the neighboring plate is the plate that is closer to the ending plate of the second ending section as measured along the principal direction of extent.

In case of at least three winding sections and accordingly at least two separation sections, at least one winding section exists that does not neighbor an ending section of the two ending sections. Each such winding section comprises two neighboring separation sections, wherein each of these two separation sections comprises a plate of the two spacing plates that is arranged at an end of the respective winding section. Between these two spacing plates, a space exists in which windings may be arranged, which windings may advantageously be at least partly shielded by the two spacing plates.

Overall, mentioned shielding provided by the two ending plates and the 2*(N-1) parallel plates of the N-1 separation sections may help prevent accidental contact between windings and soft-magnetic core elements arranged in the N-1 reception spaces.

In a further embodiment of the one-piece bobbin structure according to the application, the two ending plates and all spacing plates have equal dimensions from a perspective of the principal direction of extent, and the two ending holes of the two ending plates and all middle holes of the N-1 separation sections are aligned with each other.

In an implementation, any two spacing plates from any separation section and across different separation sections have a same size and are arranged such in the one-piece bobbin structure that—as a mathematical abstraction—a first spacing plate of the two spacing plates may be transformed into a second spacing plate of the two spacing plates by only displacing the first spacing plate along the principal direction of extent towards the second spacing plate. Similar statements may apply to the two ending plates.

In a further embodiment of the one-piece bobbin structure according to the application, the first ending section comprises a first part of a first snap-fitting mechanism, which is configured to interact with a first complementary part of the first snap-fitting mechanism to provide snap-fitting, and wherein the second ending section comprises a second part of a second snap-fitting mechanism, which is configured to interact with a second complementary part of the second snap-fitting mechanism to provide snap-fitting.

Advantageously through the snap-fitting mechanism, a plurality of one-piece bobbin structures may thus be combined to a bobbin structure arrangement as described next. Compared to a single one-piece bobbin structure, such bobbin structure arrangements that are assembled from a plurality of one-piece bobbin structures may facilitate construction of larger integrated magnetic elements.

In addition to the two snap-fitting mechanisms of the two ending sections, at least some of the separation sections may comprise parts of further snap-fitting mechanisms as well. This way, in a bobbin structure arrangement as discussed next, snap fitting may also take place between neighboring separation sections from neighboring one-piece bobbin structures.

In a second aspect, the application relates to a bobbin structure arrangement comprising M one-piece bobbin structures according to the application, with M being a natural number equal to or greater than two. All of the M one-piece bobbin structures have a same value for variable N, and the respective principal directions of extent of the M one-piece bobbin structures are parallel to one another. For any two neighboring one-piece bobbin structures of the M one-piece bobbin structures, the first ending section of a first one-piece bobbin structure of the respective two neighboring one-piece bobbin structures comprises a first part of a first snap-fitting mechanism, the first ending section of a second one-piece bobbin structure of the respective two neighboring one-piece bobbin structures comprises a first complementary part of the first snap-fitting mechanism, the second ending section of the first one-piece bobbin structure of the respective two neighboring one-piece bobbin structures comprises a second part of a second snap-fitting mechanism, and the second ending section of the second one-piece bobbin structure of the respective two neighboring one-piece bobbin structures comprises a second complementary part of the second snap-fitting mechanism. The respective two neighboring one-piece bobbin structures are snap-fitted to one another through interaction between the first part of the first snap-fitting mechanism and the first complementary part of the first snap-fitting mechanism and through interaction between the second part of the second snap-fitting mechanism and the second complementary part of the second snap-fitting mechanism. The N-1 separation sections of any one-piece bobbin structure of the M one-piece bobbin structures are bijectively related to the N-1 separation sections of any other one-piece bobbin structure of the M one-piece bobbin structures. Herein bijectively related separation sections of the M one-piece bobbin structures are arranged at substantially same positions with respect to the M parallel principal directions of extent, and the bobbin structure arrangement at least partly encloses N-1 joint reception spaces, with each joint reception space of the N-1 joint reception spaces comprising the M reception spaces which are at least partly enclosed by bijectively related separation sections.

The M one-piece bobbin structures are arranged next to one another, i.e. each one-piece bobbin structure of the M one-piece bobbin structures comprises one or two neighboring other one-piece bobbin structures of the M one-piece bobbin structures. Through snap-fitting mechanisms, any two neighboring one-piece bobbin structures may be connected to one another. Different types of snap-fitting mechanisms as known to the skilled person may be used in principle. In an implementation, the chosen snap-fitting mechanisms are such that after assembly of a bobbin structure arrangement, the bobbin structure arrangement may also be disassembled in a reversible manner.

All of the M one-piece bobbin structures of a bobbin structure arrangement comprise a same number N of winding sections and accordingly a same number N-1 of separation sections. In terms of relative positions of the N-1 separation sections along the principal direction of extent within a one-piece bobbin structure, all M one-piece bobbin structures used for the bobbin structure arrangement have the same relative positions. Accordingly, for an arbitrarily selected separation section of an arbitrarily selected one-piece bobbin structure in the bobbin structure arrangement, M-1 other separation sections exist in the bobbin structure arrangement that are arranged such that a straight line may be passed through all of these M-1 other separation sections and through the chosen separation section of the chosen one-piece bobbin structure. For the bobbin structure arrangement, in total N-1 such straight lines exist, which N-1 such straight lines are orthogonal to the parallel principal directions of extent of the M one-piece bobbin structures. Through this structural arrangement, the M one-piece bobbin structures that are snap-fitted to one another set up N-1 joint reception spaces, with each joint reception space comprising M reception spaces that in turn are provided by the M separation sections through which a straight line may be passed that is orthogonal to the principal directions of extent; each joint reception space may correspond to a union of these M reception spaces.

All M one-piece bobbin structures may be arranged such in the bobbin structure arrangement that the M first directions of the M one-piece bobbin structures are—subject to pure translational displacement in three-dimensional space—otherwise identical, i.e. all M first directions may be made coincident to one another through suitable translations. Accordingly, the N-1 joint reception spaces may inherit the M first directions from the M one-piece bobbin structures so that soft-magnetic core elements may be inserted into the N-1 joint reception spaces by being displaced substantially only along a common first direction that is parallel to the M first directions of the M one-piece bobbin structures. As the insertion directions for inserting the set of first soft-magnetic core elements and for inserting the set of second soft-magnetic core elements are different, an integrated magnetic assembly may be advantageously manufactured without needing to bend any part of the M one-piece bobbin structures which in turn mitigates risk of damage to the bobbin structure arrangement or any of its one-piece bobbin structures during assembly of the integrated magnetic assembly.

From the M one-piece bobbin structures, the bobbin structure arrangement inherits M through-holes that are parallel to one another and further comprises in total M*N winding sections.

In a third aspect, the application relates to an integrated magnetic assembly, comprising 1) a one-piece bobbin structure according to the above embodiments, 2) a set of first soft-magnetic core elements, 3) a set of second soft-magnetic core elements, and 4) at least N windings. The set of first soft-magnetic core elements have N-1 soft-magnetic core elements. Each of the first soft-magnetic core elements is arranged in a corresponding reception space of the N-1 reception spaces of the one-piece bobbin structure. As to the set of second soft-magnetic core elements, for each segment of the N segments of the through-hole of the one-piece bobbin structure, at least one of the second soft-magnetic core elements is arranged. The at least N windings are wound around the N winding sections of the one-piece bobbin structure, and the N-1 first soft-magnetic core elements of the and the second soft-magnetic core elements are arranged such that for each segment of the N segments, a respective closed-loop magnetic path exists that passes at least through the at least one of the second soft-magnetic core elements that is arranged in the respective segment, and through at least one of the N-1the first soft-magnetic core elements.

For each segment of the N segments, a closed-loop magnetic path therefore passes through the soft-magnetic core element(s) arranged in the respective segment and through the soft-magnetic core element(s) arranged in the reception space(s).

In an embodiment of the integrated magnetic assembly according to the third aspect of the application, N is equal to two and the integrated magnetic assembly has a choke winding, a primary transformer winding and a secondary transformer winding. The choke winding is wound around a first winding section of the two winding sections and the primary transformer winding and the secondary transformer winding are wound around a second winding section of the two winding sections. In this embodiment, the set of first soft-magnetic core elements comprises one I-core, which has one yoke, and the set of second soft-magnetic core elements comprises two E-cores. Each of the two E-cores has a yoke and three legs, and the three legs are parallel to one another, arranged on one side of the yoke and orthogonal to the yoke. In this embodiment, the two E-cores are arranged such that a central leg of each E-core is arranged in a corresponding segment of the two segments of the through-hole. The I-core and each of the two E-cores are dimensioned such that for each segment of the two segments a closed-loop magnetic path exists through the following magnetic core components: (i) the central leg in the respective segment, (ii) the I-core, (iii) an outer leg of the two outer legs of the E-core whose central leg is arranged in the respective segment, and (iv) the yoke of the E-core whose central leg is arranged in the respective segment.

In this embodiment, the two yokes of the two E-cores and the yoke of the I-core may substantially have equal dimensions when measured in any direction orthogonal to the principal direction of extent of the one-piece bobbin structure. Alternatively in this embodiment, the two yokes of the two E-cores and the yoke of the I-core may have different dimensions in at least some directions orthogonal to the principal direction of extent of the one-piece bobbin structure.

In this embodiment, the I-core is inserted along the first direction into the single reception space, while each of the two central legs of the two E-cores is inserted along the principal direction of extent into its respective segment of the two segments of the single through-hole.

In this embodiment, the choke winding may be electrically connected to the primary transformer winding. Such an integrated magnetic assembly may then be used for a one-phase unidirectional DC-to-DC power converter, for example, in particular for a one-phase unidirectional LLC resonant converter. The separation section of the one-piece bobbin structure is embodied such that the electrical conductor connecting the choke winding and the primary transformer winding is separated from the I-core in the reception space by the separation section. Said differently, between the connecting electrical conductor and the I-core, a part of the separation section may be arranged. Advantageously, electrical insulation of the integrated magnetic assembly may thus be improved.

Mentioned property of the separation section may be extended to all embodiments according to the third aspect of the application and to all embodiments according to the fourth aspect of the application. For any two windings that are respectively wound around two neighboring winding sections of a one-piece bobbin structure and that are electrically connected to one another, the electrical conductor connecting the two windings advantageously may be separated by the separation section separating the two neighboring winding sections from soft-magnetic core element(s) in the reception space of the separation section.

In terms of actual shape of the yokes and legs of soft-magnetic core elements of this embodiment, all other embodiments of the third aspect of the application and all embodiments of the fourth aspect of the application, the actual shape is adapted to the shape of the (joint) reception space(s) and to the shape of the segments of the through-hole(s). In case a (joint) reception space substantially corresponds in form to a rectangular cuboid, for example, an I-core, i.e. a yoke, whose shape is also a rectangular cuboid and whose dimensions are matched to the dimensions of the (joint) reception space may be inserted into such a (joint) reception space. In case a segment of a through-hole substantially corresponds in form to a rectangular cuboid, i.e. in case the corresponding winding section is embodied as a hollow cylinder with an annular rectangular base, for example, a leg whose shape is also a rectangular cuboid and whose dimensions are matched to the dimensions of the segment may be inserted into such a segment. Similar observations may hold for (joint) reception spaces that substantially correspond in form to a right circular cylinder; parts of soft-magnetic core elements that are inserted into such (joint) reception spaces may also be shaped as right circular cylinders.

In a further embodiment of the integrated magnetic assembly according to the third aspect of the application, N is equal to two and the integrated magnetic assembly has a first choke winding, a primary transformer winding and a secondary transformer winding. The first choke winding is wound around a first winding section of the two winding sections and the primary transformer winding and the secondary transformer winding are wound around a second winding section of the two winding sections. In this embodiment, the set of first soft-magnetic core elements comprises one U-core having a yoke and two legs, and the two legs are parallel to each other, arranged on one side of the yoke and orthogonal to the yoke, the yoke of the U-core is arranged in the one reception space of the one-piece bobbin structure. The set of second soft-magnetic core elements comprises two E-cores, and each of the two E-cores has a yoke and three legs. The three legs are parallel to one another, arranged on one side of the yoke and orthogonal to the yoke. The two E-cores are arranged such that a central leg of each E-core is arranged in a corresponding segment of the two segments of the through-hole, and the two outer legs of a first E-core of the two E-cores abut the two outer legs of the U-core The U-core and the two E-cores are dimensioned such that a first closed-loop magnetic path exists through the following magnetic core components: (i) the central leg of the first E-core, (ii) the yoke of the U-core, (iii) a first leg of the two legs of the U-core, (iv) the outer leg of the first E-core abutting the first leg of the two legs of the U-core, and (v) the yoke of the first E-core, and such that a second closed-loop magnetic path exists through the following magnetic core components: (i) the central leg of a second E-core of the two E-cores, (ii) the yoke of the U-core, (iii) an outer leg of the two outer legs of the second E-core and (iv) the yoke of the second E-core.

In this embodiment, the two yokes of the two E-cores and the yoke of the U-core may substantially have equal dimensions when measured in any direction orthogonal to the principal direction of extent of the one-piece bobbin structure. Alternatively in this embodiment, the two yokes of the two E-cores and the yoke of the U-core may have different dimensions in at least some directions orthogonal to the principal direction of extent of the one-piece bobbin structure.

In this embodiment, the yoke of the U-core is inserted along the first direction into the single reception space, while each of the two central legs of the two E-cores is inserted along the principal direction of extent into its respective segment of the two segments of the single through-hole.

The choke winding may be electrically connected in series to the primary transformer winding. Such an integrated magnetic assembly may be used for a one-phase unidirectional DC-to-DC power converter, for example, in particular for a one-phase unidirectional LLC resonant converter.

In a further embodiment of the integrated magnetic assembly according to the third aspect of the application, N is equal to three and the integrated magnetic assembly has a primary choke winding, a primary transformer winding, a secondary transformer winding and a secondary choke winding. The primary choke winding is wound around a first winding section of the three winding sections, the primary transformer winding and the secondary transformer winding are wound around a second winding section of the three winding sections, and the secondary choke winding is wound around a third winding section of the three winding sections. In this embodiment, the set of first soft-magnetic core elements comprises two U-cores, and each U-core has one yoke and two legs. And the two legs are parallel to one another, arranged on one side of the yoke and orthogonal to the yoke. The two yokes of the two U-cores are respectively arranged in the two reception spaces, and the two legs of a first U-core of the two U-cores respectively abut the two legs of a second U-core of the two U-cores. In this embodiment, the set of second soft-magnetic core elements comprises two E-cores and a transformer core, and each of the two E-cores has a yoke and three legs, in which the three legs are parallel to one another, arranged on one side of the yoke and orthogonal to the yoke. In this embodiment, the two E-cores are arranged such that a central leg of each E-core is arranged in a corresponding segment enclosed by the first winding section or the third winding section, and the transformer core is arranged in the segment enclosed by the second winding section.

In this embodiment, the two yokes of the two E-cores and the two yokes of the two U-cores may substantially have equal dimensions when measured in any direction orthogonal to the principal direction of extent of the one-piece bobbin structure. Alternatively in this embodiment, the two yokes of the two E-cores and the two yokes of the two U-cores may have different dimensions in at least some directions orthogonal to the principal direction of extent of the one-piece bobbin structure.

The primary choke winding may be electrically connected in series to the primary transformer winding. The secondary transformer winding may be electrically connected in series to the secondary choke winding. Such an integrated magnetic assembly may be used for a one-phase bidirectional DC-to-DC power converter, for example, in particular for a one-phase bidirectional LLC resonant converter.

In a fourth aspect, the application relates to an integrated magnetic assembly, comprising 1) a bobbin structure arrangement according to embodiments of the second aspect of the application, 2) a set of first soft-magnetic core elements, 3) a second set of soft-magnetic core elements, and 4) at least M*N windings. The set of first soft-magnetic core elements have N-1 soft-magnetic core elements, and each of the set of first soft-magnetic core elements is arranged in a corresponding joint reception space of the N-1 joint reception spaces of the bobbin structure arrangement. For each segment of the M*N segments of the M through-holes of the bobbin structure arrangement, at least one of the set of second soft-magnetic core elements is arranged. The at least M*N windings are wound around the M*N winding sections of the bobbin structure arrangement, and the N-1 first soft-magnetic core elements and the second soft-magnetic core elements are arranged such that for each segment of the M*N segments, a respective closed-loop magnetic path exists that passes at least through the at least one of the second soft-magnetic core elements that is arranged in the respective segment, and through at least one of the N-1 first soft-magnetic core elements.

Using a bobbin structure arrangement compared to a single one-piece bobbin structure, integrated magnetic assemblies may be assembled that may be used for an M-phase unidirectional or bidirectional DC-to-DC power converter, for example, in particular for M-phase unidirectional or bidirectional LLC resonant converters.

In an embodiment of the integrated magnetic assembly according to the fourth aspect of the application, N is equal to two and M is equal to two, and the integrated magnetic assembly has a first choke winding, a first primary transformer winding, a first secondary transformer winding, a second choke winding, a second primary transformer winding and a second secondary transformer winding. The first choke winding is wound around one winding section of the two winding sections of a first one-piece bobbin structure of the bobbin structure arrangement, the first primary transformer winding and the first secondary transformer winding are wound around the other winding section of the two winding sections of the first one-piece bobbin structure, the second choke winding is wound around one winding section of the two winding sections of a second one-piece bobbin structure of the bobbin structure arrangement and the second primary transformer winding and the second secondary transformer winding are wound around the other winding section of the two winding sections of the second one-piece bobbin structure. In this embodiment, the set of first soft-magnetic core elements comprises one I-core having one yoke and arranged in the one joint reception space. The set of second soft-magnetic core elements comprises two U-cores, and each of the two U-cores has a yoke and two legs. The two legs are parallel to each other, arranged on one side of the yoke and orthogonal to the yoke. The two U-cores are arranged such that the two legs of a first U-core of the two U-cores are arranged in the two segments enclosed by the two winding sections around which the first choke winding and respectively the second choke winding are wound, and the two legs of a second U-core of the two U-cores are arranged in the two segments enclosed by the two winding sections around which the first primary transformer winding and the first secondary transformer winding and respectively the second primary transformer winding and the second secondary transformer winding are wound. In this embodiment, the two U-cores and the I-core are dimensioned such that (i) a first closed-loop magnetic path exists through the yoke of the first U-core, the two legs of the first U-core and the I-core, and such that (ii) a second closed-loop magnetic path exists through the yoke of the second U-core, the two legs of the second U-core and the I-core.

In this embodiment, the two yokes of the two U-cores and the yoke of the I-core may substantially have equal dimensions when measured in any direction orthogonal to the two principal directions of extent of the two one-piece bobbin structures. Alternatively in this embodiment, the two yokes of the two U-cores and the yoke of the I-core may have different dimensions in at least some directions orthogonal to the two principal directions of extent of the two one-piece bobbin structures.

The first choke winding may be electrically connected in series to the first primary transformer winding, and the second choke winding may be electrically connected in series to the second primary transformer winding. Such an integrated magnetic assembly may be used for a one-phase unidirectional DC-to-DC power converter, for example, in particular for a one-phase unidirectional LLC resonant converter.

In a further embodiment of the integrated magnetic assembly according to the fourth aspect of the application, N is equal to two and M is equal to three, and the integrated magnetic assembly has a first choke winding, a first primary transformer winding, a first secondary transformer winding, a second choke winding, a second primary transformer winding and a second secondary transformer winding, a third choke winding, a third primary transformer winding and a third secondary transformer winding, In this embodiment, the first choke winding is wound around one winding section of the two winding sections of a first one-piece bobbin structure of the bobbin structure arrangement, and the first primary transformer winding and the first secondary transformer winding are wound around the other winding section of the two winding sections of the first one-piece bobbin structure. In this embodiment, the second choke winding is wound around one winding section of the two winding sections of a second one-piece bobbin structure of the bobbin structure arrangement, and the second primary transformer winding and the second secondary transformer winding are wound around the other winding section of the two winding sections of the second one-piece bobbin structure. In this embodiment, the third choke winding is wound around one winding section of the two winding sections of a third one-piece bobbin structure of the bobbin structure arrangement and the third primary transformer winding and the third secondary transformer winding are wound around the other winding section of the two winding sections of the third one-piece bobbin structure. In this embodiment, the set of first soft-magnetic core elements comprises one I-core having one yoke and arranged in the one joint reception space. The set of second soft-magnetic core elements comprises two E-cores, and each of the two E-cores has a yoke and three legs and the three legs are parallel to one another, arranged on one side of the yoke and orthogonal to the yoke. In this embodiment, the two E-cores are arranged such that the three legs of a first E-core of the two E-cores are arranged in the three segments enclosed by the three winding sections around which the first choke winding, the second choke winding and respectively the third choke winding are wound. And the three legs of a second E-core of the two E-cores are arranged in the three segments enclosed by the three winding sections around which the first primary transformer winding and the first secondary transformer winding, the second primary transformer winding and the second secondary transformer winding and respectively the third primary transformer winding and the third secondary transformer winding are wound.

In this embodiment, the two yokes of the two E-cores and the yoke of the I-core may substantially have equal dimensions when measured in any direction orthogonal to the three principal directions of extent of the three one-piece bobbin structures. Alternatively in this embodiment, the two yokes of the two E-cores and the yoke of the I-core may have different dimensions in at least some directions orthogonal to the three principal directions of extent of the three one-piece bobbin structures.

The first choke winding may be electrically connected in series to the first primary transformer winding, the second choke winding may be electrically connected in series to the second primary transformer winding and the third choke winding may be electrically connected in series to the third primary transformer winding. Such an integrated magnetic assembly may be used for a three-phase unidirectional DC-to-DC power converter, for example, in particular for a three-phase unidirectional LLC resonant converter.

In a further embodiment of the integrated magnetic assembly according to the fourth aspect of the application, N is equal to two and M is equal to two, and the integrated magnetic assembly has a first choke winding, a first primary transformer winding, a first secondary transformer winding, a second choke winding, a second primary transformer winding and a second secondary transformer winding. In this embodiment, the first choke winding is wound around one winding section of the two winding sections of a first one-piece bobbin structure of the bobbin structure arrangement, and the first primary transformer winding and the first secondary transformer winding are wound around the other winding section of the two winding sections of the first one-piece bobbin structure. In this embodiment, the second choke winding is wound around one winding section of the two winding sections of a second one-piece bobbin structure of the bobbin structure arrangement, and the second primary transformer winding and the second secondary transformer winding are wound around the other winding section of the two winding sections of the second one-piece bobbin structure. In this embodiment, the set of first soft-magnetic core elements comprises one I-core having one yoke and arranged in the one joint reception space. The set of second soft-magnetic core elements comprises two E-cores, each of the two E-cores has a yoke and three legs and the three legs are parallel to each other, arranged on one side of the yoke and orthogonal to the yoke. In this embodiment, the two E-cores are arranged such that the two outer legs of a first E-core of the two E-cores are arranged in the two segments enclosed by the two winding sections around which the first choke winding and respectively the second choke winding are wound, and the two outer legs of a second E-core of the two E-cores are arranged in the two segments enclosed by the two winding sections around which the first primary transformer winding and the first secondary transformer winding and respectively the second primary transformer winding and the second secondary transformer winding are wound. In this embodiment, the two E-cores and the I-core are dimensioned such that (i) a first closed-loop magnetic path exists through the yoke of the first E-core, an outer leg of the first E-core, the I-core and a central leg of the first E-core, and such that (ii) a second closed-loop magnetic path exists through the yoke of the second E-core, an outer leg of the second E-core, the I-core and a central leg of the second E-core.

In this embodiment, the two yokes of the two E-cores and the yoke of the I-core may substantially have equal dimensions when measured in any direction orthogonal to the two principal directions of extent of the two one-piece bobbin structures. Alternatively in this embodiment, the two yokes of the two E-cores and the yoke of the I-core may have different dimensions in at least some directions orthogonal to the two principal directions of extent of the two one-piece bobbin structures.

The first choke winding may be electrically connected in series to the first primary transformer winding and the second choke winding may be electrically connected in series to the second primary transformer winding. Such an integrated magnetic assembly may be used for a two-phase unidirectional DC-to-DC power converter, for example, in particular for a two-phase unidirectional LLC resonant converter.

In a further embodiment of the integrated magnetic assembly according to the fourth aspect of the application, N is equal to two and M is equal to three, and the integrated magnetic assembly has a first choke winding, a first primary transformer winding, a first secondary transformer winding, a second choke winding, a second primary transformer winding and a second secondary transformer winding, a third choke winding, a third primary transformer winding and a third secondary transformer winding. In this embodiment, the first choke winding is wound around one winding section of the two winding sections of a first one-piece bobbin structure of the bobbin structure arrangement, and the first primary transformer winding and the first secondary transformer winding are wound around the other winding section of the two winding sections of the first one-piece bobbin structure. In this embodiment, the second choke winding is wound around one winding section of the two winding sections of a second one-piece bobbin structure of the bobbin structure arrangement, and the second primary transformer winding and the second secondary transformer winding are wound around the other winding section of the two winding sections of the second one-piece bobbin structure. In this embodiment, the third choke winding is wound around one winding section of the two winding sections of a third one-piece bobbin structure of the bobbin structure arrangement and the third primary transformer winding and the third secondary transformer winding are wound around the other winding section of the two winding sections of the third one-piece bobbin structure. In this embodiment, the set of first soft-magnetic core elements comprises one I-core having one yoke and arranged in the one joint reception space. The set of second soft-magnetic core elements comprises two W-cores, each of the two W-cores has a yoke and five legs and the five legs are parallel to one another, arranged on one side of the yoke and orthogonal to the yoke. In this embodiment, the two W-cores are arranged such that two outer legs and one central leg of a first W-core of the two W-cores are arranged in the three segments enclosed by the three winding sections around which the first choke winding, the second choke winding and respectively the third choke winding are wound. Two outer legs and one central leg of a second W-core of the two W-cores are arranged in the three segments enclosed by the three winding sections around which the first primary transformer winding and the first secondary transformer winding respectively the second primary transformer winding and the second secondary transformer winding and respectively the third primary transformer winding and the third secondary transformer winding are wound.

In this embodiment, the two yokes of the two W-cores and the yoke of the I-core may substantially have equal dimensions when measured in any direction orthogonal to the three principal directions of extent of the three one-piece bobbin structures. Alternatively in this embodiment, the two yokes of the two W-cores and the yoke of the I-core may have different dimensions in at least some directions orthogonal to the three principal directions of extent of the three one-piece bobbin structures.

The first choke winding may be electrically connected in series to the first primary transformer winding, the second choke winding may be electrically connected in series to the second primary transformer winding and the third choke winding may be electrically connected in series to the third primary transformer winding. Such an integrated magnetic assembly may be used for a three-phase unidirectional DC-to-DC power converter, for example, in particular for a three-phase unidirectional LLC resonant converter.

In a further embodiment of the integrated magnetic assembly according to the fourth aspect of the application, N is equal to three and M is equal to two, and the integrated magnetic assembly has a first primary choke winding, a first primary transformer winding, a first secondary transformer winding, a first secondary choke winding, a second primary choke winding, a second primary transformer winding, a second secondary transformer winding and a second secondary choke winding. In this embodiment, the first primary choke winding is wound around a first winding section of the three winding sections of a first one-piece bobbin structure of the bobbin structure arrangement, the first primary transformer winding and the first secondary transformer winding are wound around a second winding section of the three winding sections of the first one-piece bobbin structure and the first secondary choke winding is wound around a third winding section of the three winding sections of the first one-piece bobbin structure. In this embodiment, the second primary choke winding is wound around a first winding section of the three winding sections of a second one-piece bobbin structure of the bobbin structure arrangement, the second primary transformer winding and the second secondary transformer winding are wound around a second winding section of the three winding sections of the second one-piece bobbin structure, and the second secondary choke winding is wound around a third winding section of the three winding sections of the second one-piece bobbin structure. In this embodiment, the set of first soft-magnetic core elements comprises two I-cores, each I-core has one yoke, and the two I-cores are arranged in the two joint reception spaces. And the set of second soft-magnetic core elements comprises two U-cores and two transformer cores, each of the two U-cores has a yoke and two legs and the two legs are parallel to each other, arranged on one side of the yoke and orthogonal to the yoke. In this embodiment, the two U-cores are arranged such that the two legs of a first U-core of the two U-cores are arranged in the two segments enclosed by the two winding sections around which the first primary choke winding and respectively the second primary choke winding are wound, and the two legs of a second U-core of the two U-cores are arranged in the two segments enclosed by the two winding sections around which the first secondary choke winding respectively the second secondary choke winding are wound. In this embodiment, the two transformer cores are arranged in the two segments enclosed by the two winding sections around which the first primary transformer winding and the first secondary transformer winding and respectively the second primary transformer winding and the second secondary transformer winding are wound.

In this embodiment, the two yokes of the two U-cores and the two yokes of the two I-cores may substantially have equal dimensions when measured in any direction orthogonal to the two principal directions of extent of the two one-piece bobbin structures. Alternatively in this embodiment, the two yokes of the two U-cores and the two yokes of the two I-cores may have different dimensions in at least some directions orthogonal to the two principal directions of extent of the two one-piece bobbin structures.

The first primary choke winding may be electrically connected in series to the first primary transformer winding. The first secondary transformer winding may be electrically connected in series to the first secondary choke winding. The second primary choke winding may be electrically connected in series to the second primary transformer winding. The second secondary transformer winding may be electrically connected in series to the second secondary choke winding. Such an integrated magnetic assembly may be used for a one-phase bidirectional DC-to-DC power converter, for example, in particular for a one-phase bidirectional LLC resonant converter.

Further advantageous embodiments and combinations of features of the application result from the following exemplary embodiments as a whole.

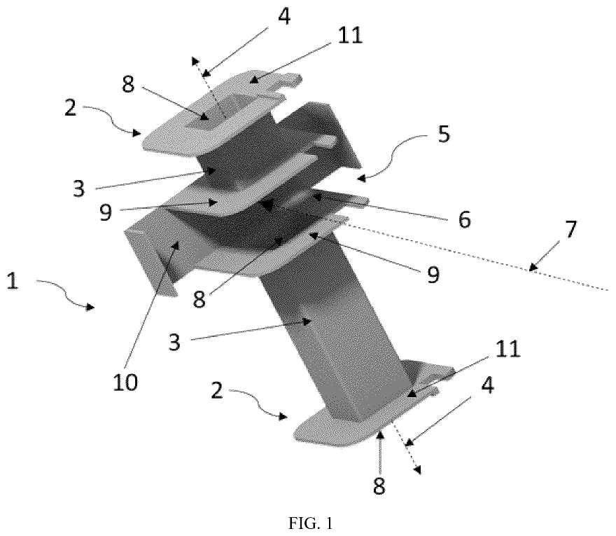

FIG. 1 shows an embodiment of a one-piece bobbin structure 1. The one-piece bobbin structure 1 comprises two ending sections 2, two winding sections 3 and a separation section 5 between the two winding sections 3. The separation section 5 at least partly encloses a reception space 6.

Both ending sections 2 comprise ending plates 11 with a hole. The one-piece bobbin structure 1 comprises a through-hole 8 that passes through the two holes of the ending plates 11. The separation section 5 comprises two spacing plates 9 that are parallel to one another and that both comprise a hole through which the through-hole 8 passes. The through-hole 8 further passes through the reception space 6. The separation section 5 also comprises a third bottom plate 10 that is orthogonal to the two spacing plates 9 and that connects the two spacing plates 9 between corresponding edges of the two spacing plates 9.

The one-piece bobbin structure 1 comprises a principal direction of extent 4 that passes through the through-hole 8. The two spacing plates 9 of the separation section 5 are orthogonal to the principal direction of extent 4. The one-piece bobbin structure 1 further comprises a first direction 7 that is orthogonal to the principal direction of extent 4.

A suitably shaped soft-magnetic core element, in particular embodied as a properly dimensioned rectangular cuboid, may be inserted into the reception space 6 by substantially only being displaced along the first direction 7, while another suitably shaped soft-magnetic core element, in particular embodied as a properly dimensioned rectangular cuboid, may be inserted into the through-hole 8 by substantially only being displaced along the principal direction of extent 4. In the embodiment of FIG. 1, the two winding sections are embodied as hollow cylinders with an annular rectangular base.

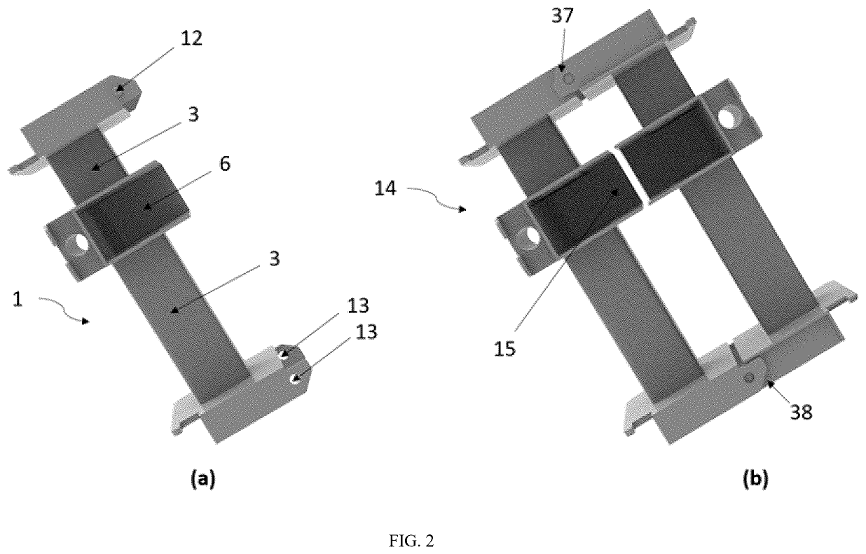

FIG. 2a show an embodiment of a one-piece bobbin structure 1, while FIG. 2b shows an embodiment of a bobbin structure arrangement 14 assembled from one-piece bobbin structures. At a first ending section of the two ending sections of the one-piece bobbin structure of FIG. 2a, a part 12 of a first snap-fitting mechanism is arranged, while at a second ending section of the two ending section of the one-piece bobbin structure of FIG. 2a, a part 13 of a second snap-fitting mechanism is arranged. Through these parts, the one-piece bobbin structure 1 of FIG. 2a may be snap-fitted to another one-piece bobbin structure. More specifically and as shown in FIG. 2b, a second one-piece bobbin structure comprises at its first ending section a complementary part 37 of the first snap-fitting mechanism and at its second ending section a complementary part 38 of the second snap-fitting mechanism. Together, the part 12 and the complementary part 37 provide snap fitting and the part 13 and the complementary part 38 provide snap fitting. In principle, different types of snap-fitting mechanisms may be used.

The bobbin structure arrangement 14 of FIG. 2a comprises a joint reception space 15 that comprises the two reception spaces 6 of the two one-piece bobbin structures 1 from which the bobbin structure arrangement 14 is formed. The joint reception space 15 is only accessible through one side of a rectangular cuboid.

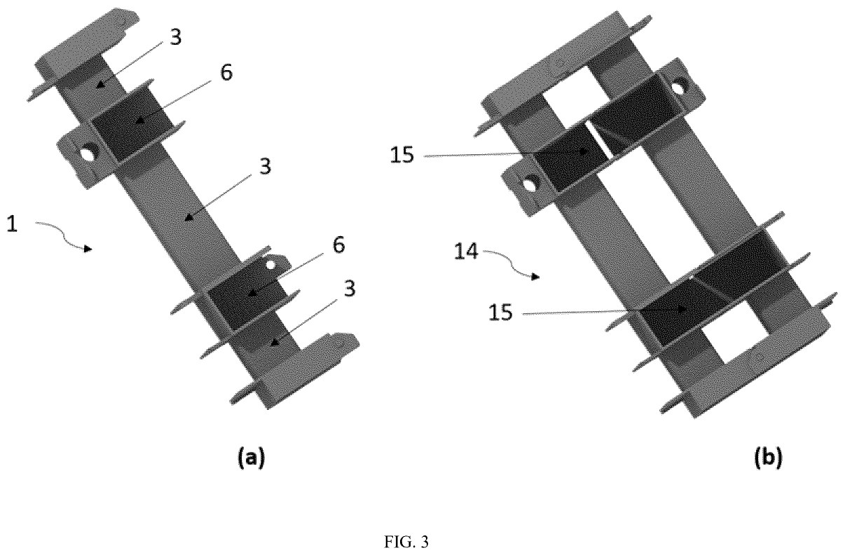

FIG. 3a is similar to FIG. 2a, the main difference being that instead of two winding sections 3 and one separation section 5 as in FIG. 2a, the one-piece bobbin structure 1 of FIG. 3a comprises three winding sections 3 and two separation sections 5 that at least partly enclose two reception spaces 6. In FIG. 3b, a bobbin structure arrangement 14 is shown that is assembled from such one-piece bobbin structures 1. In addition to the snap-fitting mechanisms on the two ending sections, in the embodiment of FIG. 3, the bottom separation structure comprises a part of a further snap-fitting mechanism that may provide snap fitting together with a complementary part of the further snap-fitting mechanism, as indicated in FIG. 3b by the absence of a gap in the bottom joint reception space 15 compared to the top joint reception space 15. The two joint reception spaces 15 are each only accessible through one side of a rectangular cuboid

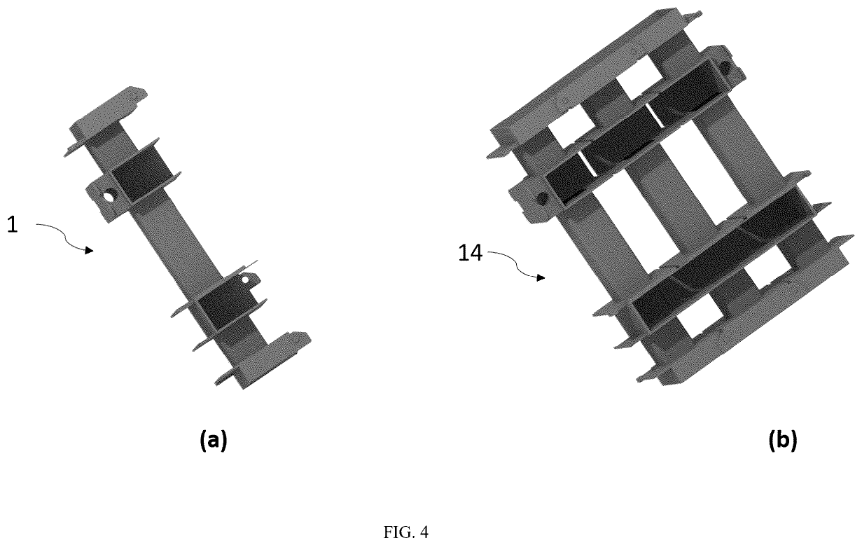

The embodiment of FIG. 4a corresponds to the embodiment of FIG. 3a. In the bobbin structure arrangement 14 of FIG. 4b, two joint reception spaces are visible that are provided by three one-piece bobbin structures. As visible in FIG. 4b, both the ending sections and the separation sections of the three one-piece bobbin structures have slight constructional differences to account for their relative positioning within the bobbin structure arrangement 14. In the embodiment of FIG. 4b, the two joint reception spaces are each only accessible through one side of a rectangular cuboid.

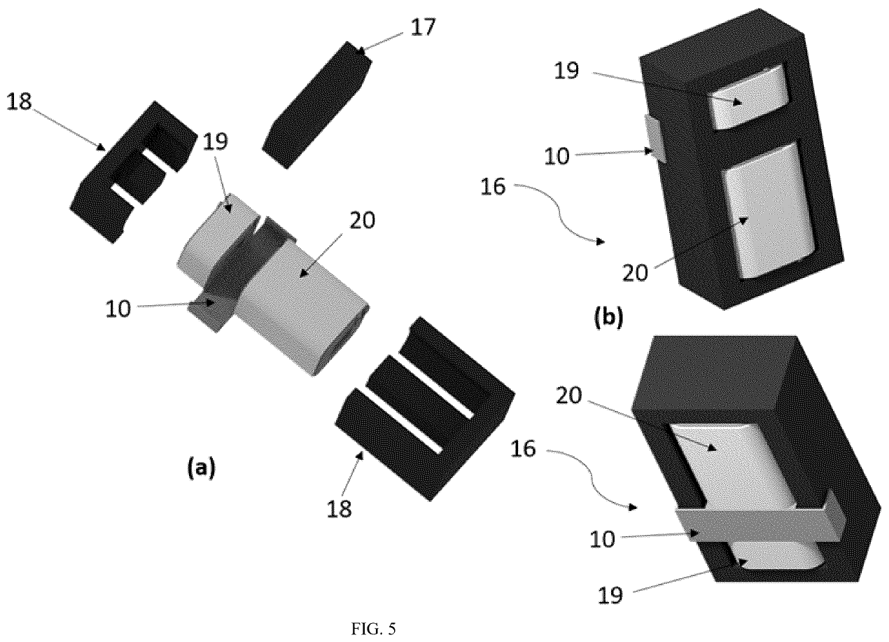

FIG. 5a shows a partly exploded view of an integrated magnetic assembly 16 as visible in FIG. 5b in two different views. For the integrated magnetic assembly 16 of FIG. 5, a one-piece bobbin structure as visible in FIG. 1 is used. An I-core 17 is inserted into the reception space 6 along the first direction 7 until it reaches the third bottom plate 10. In terms of windings, the integrated magnetic assembly 16 comprises a choke winding 19 and a primary transformer winding 20 and a secondary transformer winding 20 that are both wound around the same winding section of the one-piece bobbin structure. A central leg of a first E-core 18 is inserted into the segment of the through-hole 8 around which the choke winding 19 is wound, and a central leg of a second E-core 18 is inserted into the segment of the through-hole 8 around which the two transformer windings 20 are wound. Through the four outer legs of the two E-cores and the I-core, closed-loop magnetic paths are provided.

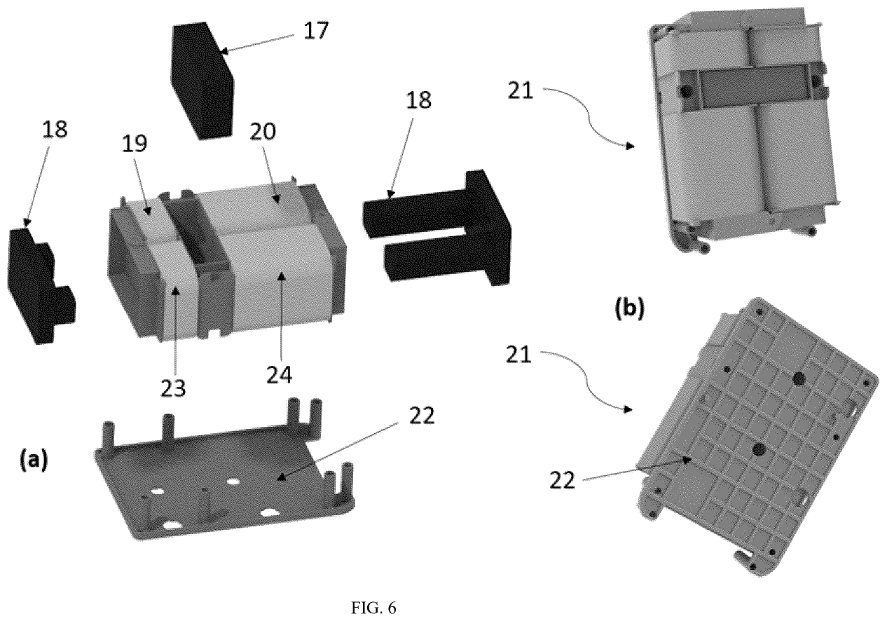

FIG. 6a shows a partly exploded view of an integrated magnetic assembly 21 as visible in FIG. 6b in two different views. The integrated magnetic assembly 21 comprises a bobbin structure arrangement 14 of FIG. 2b and a first choke winding 19, a first pair of primary and secondary transformer windings 20, a second choke winding 23 and a second pair of primary and secondary transformer windings 24. An I-core 17 is inserted into the joint reception space, while the four legs of two U-cores are inserted into the two through-holes 8. The integrated magnetic assembly 21 comprises a baseplate 22.

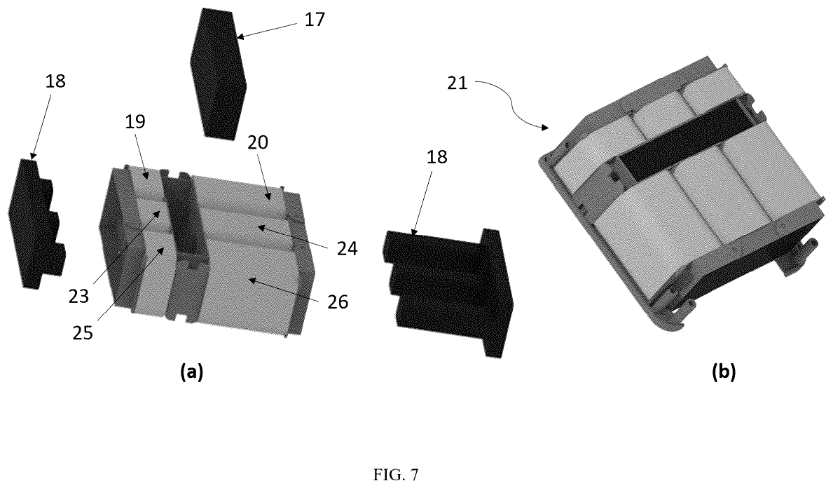

FIG. 7a shows a partly exploded view of an integrated magnetic assembly 21 as visible in FIG. 7b. The integrated magnetic assembly 21 comprises a bobbin structure arrangement with M=3 and N=2. In terms of windings, the integrated magnetic assembly 21 comprises a first choke winding 19, a second choke winding 23, a third choke winding 25, a first pair of primary and secondary transformer windings 20, a second pair of primary and secondary transformer windings 24 and a third pair of primary and secondary transformer windings 26. An I-core 17 is inserted into the joint reception space. The six legs of two E-cores 18 are inserted into the three through-holes 8 of the bobbin structure arrangement.

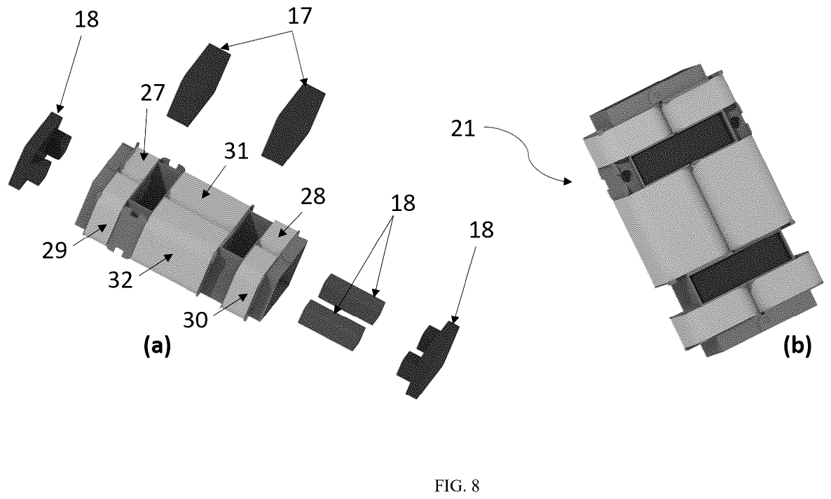

FIG. 8a shows a partly exploded view of an integrated magnetic assembly 21 as visible in FIG. 8b. The integrated magnetic assembly 21 comprises a bobbin structure arrangement with M=2 and N=3. In terms of windings, the integrated magnetic assembly 21 comprises a first primary choke winding 27, a first secondary choke winding 28, a second primary choke winding 29, a second secondary choke winding 30, a first pair of primary and secondary transformer windings 31 and a second pair of primary and secondary transformer windings 32. Two I-cores 17 are inserted into the two joint reception spaces. Two transformer cores 18 that are each embodied as a rectangular cuboid are inserted into the two through-holes 8 until they are in the two segments around which the first pair of primary and secondary transformer windings 31 and the second pair of primary and secondary transformer windings 32 are wound. The four legs of two U-cores 18 are inserted into the two through-holes 8.

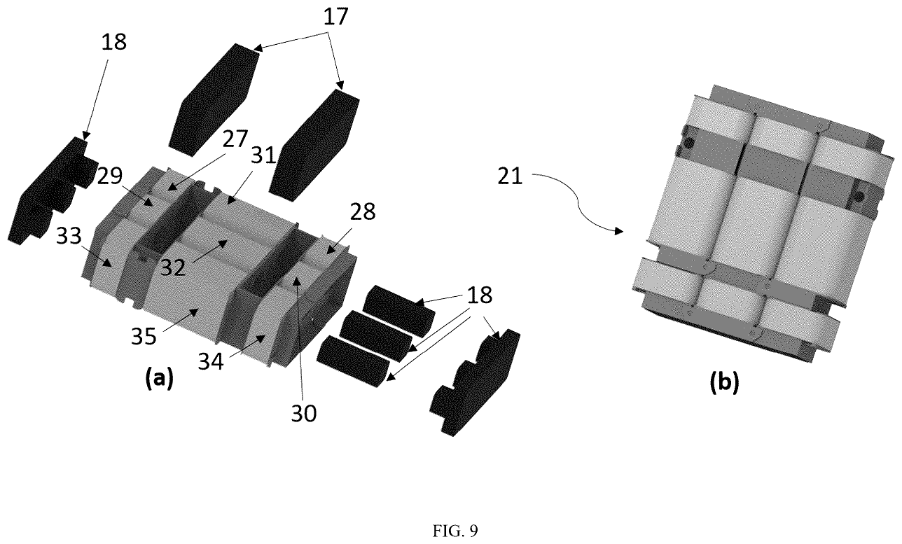

FIG. 9a shows a partly exploded view of an integrated magnetic assembly 21 as visible in FIG. 9b. The integrated magnetic assembly 21 comprises a bobbin structure arrangement with M=3 and N=3. In terms of windings, the integrated magnetic assembly 21 comprises a first primary choke winding 27, a first secondary choke winding 28, a second primary choke winding 29, a second secondary choke winding 30, a third primary choke winding 33, a third secondary choke winding 34, a first pair of primary and secondary transformer windings 31, a second pair of primary and secondary transformer windings 32 and a third pair of primary and secondary transformer windings 35. Two I-cores 17 are inserted into the two joint reception spaces. Three transformer cores 18 that are each embodied as a rectangular cuboid are inserted into the three through-holes 8 until they are in the three segments around which the first pair of primary and secondary transformer windings 31 and the second pair of primary and secondary transformer windings 32 and the third pair of primary and secondary transformer windings 35 are wound. The six legs of two E-cores 18 are inserted into the three through-holes 8.

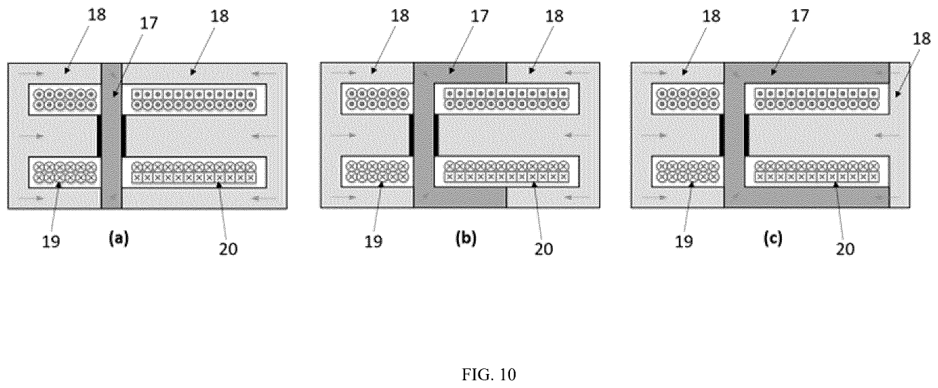

The arrows imprinted on soft-magnetic core elements 17, 18 in FIGS. 10 to 19 indicate whether a soft-magnetic core element is inserted into a one-piece bobbin structure and respectively a bobbin structure arrangement by being displaced along a principal direction of extent 4 (indicated by horizontal arrows ‘→’ and ‘←’ which arrows also indicate direction of insertion) or along a first direction 7 (indicated by northeast and southeast arrows ‘ [symbol] ’ and ‘ [symbol] ’). In all of FIGS. 10 to 19, thick black lines indicate air gaps. In FIG. 10a, for example, two such air gaps are present, with one air gap being arranged between the central leg of the left E-core 18 and the I-core 17 and another air gap being arranged between the central leg of the right E-core 18 and the I-core 17.

The integrated magnetic assembly corresponding to FIG. 10 comprises a one-piece bobbin structure with N=2. In terms of windings, the integrated magnetic assembly comprises a choke winding 19 and a pair of primary and secondary transformer windings 20. In FIG. 10a, two central legs of two E-cores 18 are inserted into the through-hole 8 and an I-core 17 is inserted into the reception space of the one-piece bobbin structure. Compared to FIG. 10a, in FIG. 10b the two outer legs of the right E-core are shortened and abut the two legs of a U-core 17 that replaces the I-core 17 of FIG. 10a. In FIG. 10b, a yoke of the U-core 17 is inserted into the reception space of the one-piece bobbin structure. Compared to FIG. 10b, in FIG. 10c, the two legs of the U-core fully replaced the two outer legs of the E-core 18 of FIG. 10b.

The integrated magnetic assembly corresponding to FIG. 11 comprises a bobbin structure arrangement with M=2 and N=2. In terms of windings, the integrated magnetic assembly comprises a first choke winding 19, a second choke winding 23, a first pair of primary and secondary transformer windings 20 and a second pair of primary and secondary transformer windings 24. In FIG. 11a, the four legs of two U-cores 18 are inserted into the two through-holes and an I-core 17 is inserted into the joint reception space. Compared to FIG. 11a, in FIG. 11b the right U-core is replaced by two transformer cores 18 and an I-core 18.

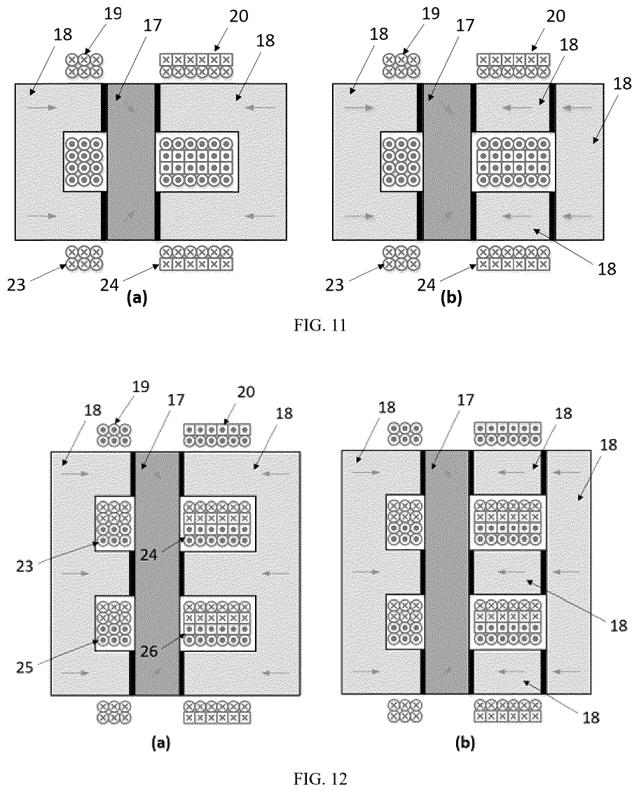

The integrated magnetic assembly corresponding to FIG. 12 comprises a bobbin structure arrangement with M=3 and N=2. In terms of windings, the integrated magnetic assembly comprises a first choke winding 19, a second choke winding 23, a third choke winding 25, a first pair of primary and secondary transformer windings 20, a second pair of primary and secondary transformer windings 24 and a third pair of primary and secondary transformer windings 26. In FIG. 12a, the six legs of two E-cores 18 are inserted into the three through-holes and an I-core 17 is inserted into the joint reception space. Compared to FIG. 12a, in FIG. 12b the right E-core is replaced by three transformer cores 18 and an I-core 18.

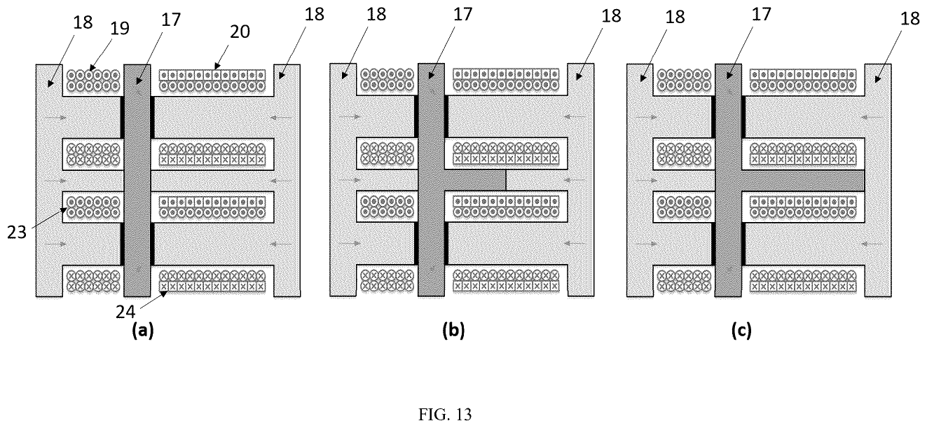

The integrated magnetic assembly corresponding to FIG. 13 comprises a bobbin structure arrangement with M=2 and N=2. In terms of windings, the integrated magnetic assembly comprises a first choke winding 19, a second choke winding 23, a first pair of primary and secondary transformer windings 20 and a second pair of primary and secondary transformer windings 24. In FIG. 13a, the four outer legs of two E-cores 18 are inserted into the two through-holes and an I-core 17 is inserted into the joint reception space. Compared to FIG. 13a, in FIG. 13b the central leg of the right E-core is shortened and abuts an added leg of the soft-magnetic core element 17. In FIG. 13c, the central leg of the right soft-magnetic core element is fully removed and replaced by the added leg of the soft-magnetic core element 17.

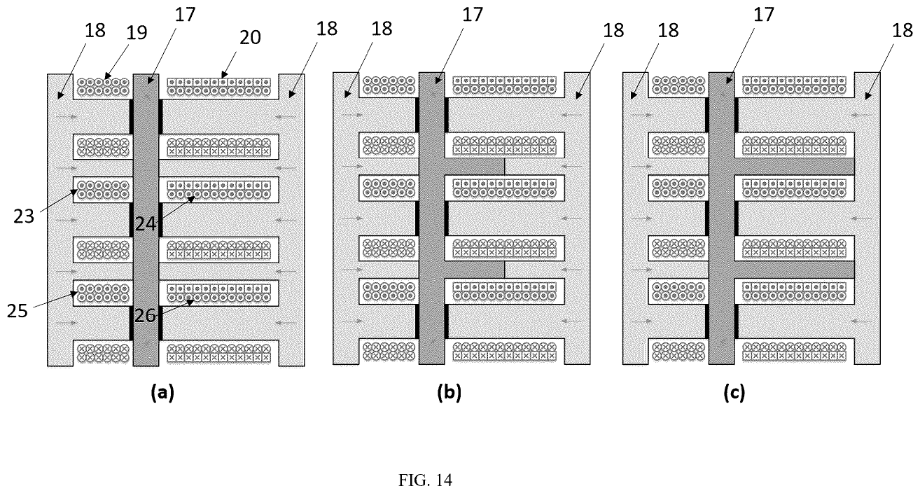

The integrated magnetic assembly corresponding to FIG. 14 comprises a bobbin structure arrangement with M=3 and N=2. In terms of windings, the integrated magnetic assembly comprises a first choke winding 19, a second choke winding 23, a third choke winding 25, a first pair of primary and secondary transformer windings 20, a second pair of primary and secondary transformer windings 24 and a third pair of primary and secondary transformer windings 26. In FIG. 14a, the two central legs and the four outer legs of two W-cores 18 are inserted into the three through-holes and an I-core 17 is inserted into the joint reception space. Compared to FIG. 13a, in FIG. 13b the two intermediate legs of the right W-core, which two intermediate legs are arranged between the central leg and the two outer legs of the W-core, are shortened and abut two added legs of the soft-magnetic core element 17. In FIG. 14c, the two intermediate legs of the right soft magnetic core element are fully removed, thereby changing the W-core of FIG. 14a and FIG. 14b into an E-core, and replaced by the two added legs of the soft-magnetic core element 17.

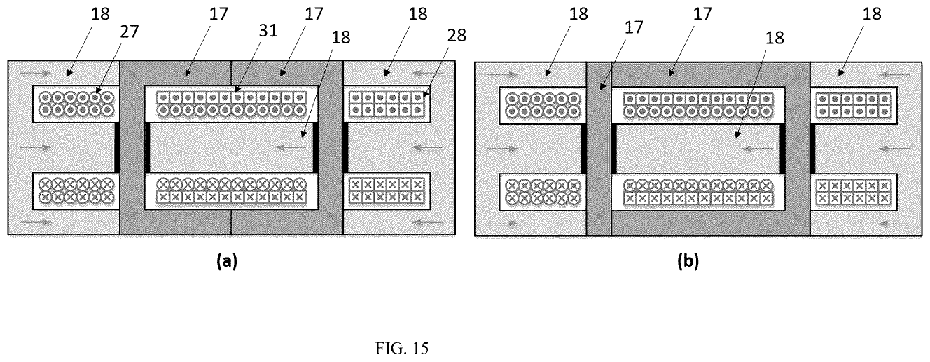

The integrated magnetic assembly corresponding to FIG. 15 comprises a one-piece bobbin structure with N=3. In terms of windings, the integrated magnetic assembly comprises a primary choke winding 27, a secondary choke winding 28 and a pair of primary and secondary transformer windings 31. In FIG. 15a, a transformer core 18 is inserted into the segment of the through-hole around which segment the primary and secondary transformer windings 31 are wound. Two central legs of the E-cores 18 are inserted into the through-hole as well. Two yokes of two U-cores 17 are inserted into the two reception spaces. The four legs of the two U-cores 17 abut each other. Compared to FIG. 15a, in FIG. 15b the left U-core is replaced by an I-core 17 and the two legs of the right U-core are made longer.

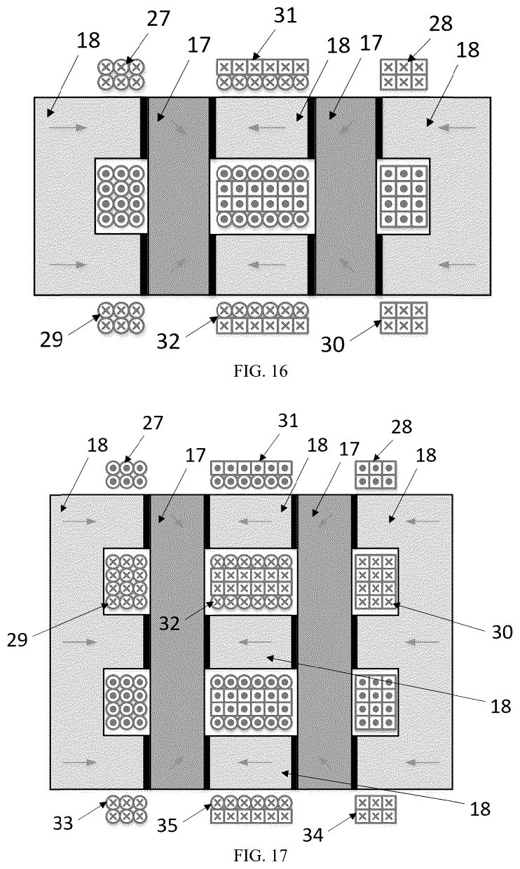

The integrated magnetic assembly corresponding to FIG. 16 comprises a bobbin structure arrangement with M=2 and N=3. In terms of windings, the integrated magnetic assembly comprises a first primary choke winding 27, a first secondary choke winding 28, a second primary choke winding 29, a second secondary choke winding 30, a first pair of primary and secondary transformer windings 31 and a second pair of primary and secondary transformer windings 32. In FIG. 16, two transformer cores 18 are inserted into the two segments of the two through-holes around which two segments the two pairs 31, 32 of transformer windings are wound. Four legs of two U-cores 18 are inserted into the two through-holes as well. Two I-cores 17 are inserted into the two joint reception spaces.

The integrated magnetic assembly corresponding to FIG. 17 comprises a bobbin structure arrangement with M=3 and N=3. In terms of windings, the integrated magnetic assembly comprises a first primary choke winding 27, a first secondary choke winding 28, a second primary choke winding 29, a second secondary choke winding 30, a third primary choke winding 33, a third secondary choke winding 34, a first pair of primary and secondary transformer windings 31, a second pair of primary and secondary transformer windings 32 and a third pair of primary and secondary transformer windings 35. Two I-cores 17 are inserted into the two joint reception spaces. Three transformer cores 18 are inserted into the three segments of the three through-holes around which three segments the three pairs 31, 32, 35 of transformer windings are wound. Three legs of two E-cores 18 are inserted into the three through-holes as well.

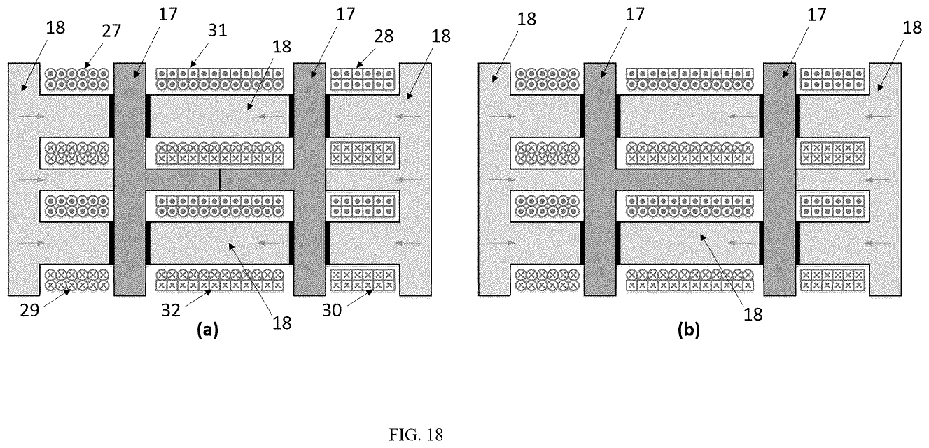

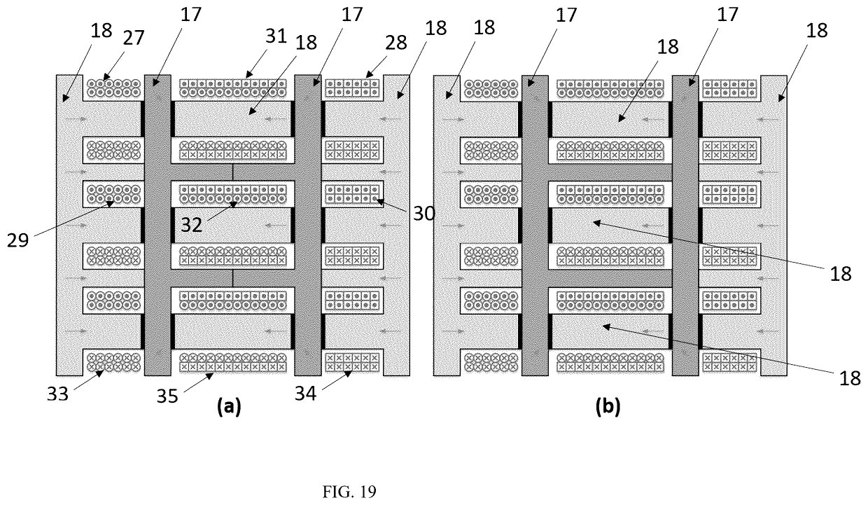

The integrated magnetic assembly corresponding to FIG. 18 comprises a bobbin structure arrangement with M=2 and N=3. In terms of windings, the integrated magnetic assembly comprises a first primary choke winding 27, a first secondary choke winding 28, a second primary choke winding 29, a second secondary choke winding 30, a first pair of primary and secondary transformer windings 31 and a second pair of primary and secondary transformer windings 32. In FIG. 18a, the four outer legs of two E-cores 18 are inserted into the two through-holes. Two transformer cores 18 are inserted into the two segments of the two through-holes around which two segments the two pairs 31, 32 of transformer windings are wound. The yokes of two soft-magnetic core elements 17 are inserted into the two joint reception spaces. Each of the soft-magnetic core elements 17 comprises a further leg, with the two further legs abutting each other. Compared to FIG. 18a, in FIG. 18b the right soft-magnetic core element is replaced by an I-core 17 and the further leg of the left soft-magnetic core element 17 is made longer.

The integrated magnetic assembly corresponding to FIG. 19 comprises a bobbin structure arrangement with M=3 and N=3. In terms of windings, the integrated magnetic assembly comprises a first primary choke winding 27, a first secondary choke winding 28, a second primary choke winding 29, a second secondary choke winding 30, a third primary choke winding 33, a third secondary choke winding 34, a first pair of primary and secondary transformer windings 31, a second pair of primary and secondary transformer windings 32 and a third pair of primary and secondary transformer windings 35. In FIG. 19a, the two central legs and the four outer legs of two W-cores 18 are inserted into the three through-holes. Three transformer cores 18 are inserted into the three segments of the three through-holes around which three segments the three pairs 31, 32, 35 of transformer windings are wound. The yokes of two soft-magnetic core elements 17 are inserted into the two joint reception spaces. Each of the soft-magnetic core elements 17 comprises two further leg, with the four further legs abutting each other. Compared to FIG. 19a, in FIG. 19b the right soft-magnetic core element is replaced by an I-core 17 and the two further legs of the left soft-magnetic core element 17 are made longer.

While the application has been described by way of example and in terms of embodiments described above, it should be understood that the application is not limited to the disclosed embodiments. On the contrary, it is intended to cover various modifications and similar arrangements (as would be apparent to those skilled in the art). Therefore, the scope of the appended claims should be accorded with the broadest interpretation so as to encompass all such modifications and similar arrangements.

What is claimed is:

1. A one-piece bobbin structure for an integrated magnetic assembly, the one-piece bobbin structure comprising
two ending sections, comprising a first ending section and a second ending section;
N winding sections, consecutively arranged along a principal direction of extent between the first ending section and the second ending section, N being a natural number equal to two or three; and
N-1 separation sections;
wherein any two neighboring winding sections of the N winding sections are separated from each other by a corresponding separation section of the N-1 separation sections, each separation section of the N-1 separation sections is embodied such that it at least partly encloses a respective reception space from three sides;
wherein the N-1 separation sections are configured for receiving a set of first soft-magnetic core elements in the N-1 reception spaces, and wherein the N-1 separation sections are embodied such that the first soft-magnetic core elements are insertable into the N-1 reception spaces by displacing the first soft-magnetic core elements along a first direction, which is distinct from the principal direction of extent,
wherein the one-piece bobbin structure is embodied such that
a through-hole passes from the first ending section to the second ending section along the principal direction of extent, with N segments of the through-hole being enclosed by the N winding sections, with the through-hole passing through the N-1 reception spaces, and with the principal direction of extent passing through the through-hole; and
a set of second soft-magnetic core elements are insertable into the through-hole from the first ending section towards the second ending section or from the second ending section towards the first ending section, by displacing the second soft-magnetic core elements along the principal direction of extent.

2. The one-piece bobbin structure according to claim 1, wherein each of the N winding sections is embodied as a hollow cylinder whose respective axis is parallel to the principal direction of extent, with each hollow cylinder surrounding a respective hollow interior, and with the N hollow interiors being the N segments of the through-hole.

3. The one-piece bobbin structure according to claim 2, wherein each hollow cylinder has a rectangular base or a circular base.

4. The one-piece bobbin structure according to claim 2, wherein each separation section of the N-1 separation sections comprises two spacing plates that are parallel to one another, oriented in an orthogonal manner with respect to the principal direction of extent, and are spaced apart from one another along the principal direction of extent, and each of the two spacing plates comprises a middle hole.

5. The one-piece bobbin structure according to claim 4, wherein the one-piece bobbin structure is embodied such that the through-hole passes through the two middle holes in the two spacing plates of each separation section, and each separation section separates two neighboring winding sections, a first spacing plate of the two spacing plates is arranged at a first end of a first winding section of the two neighboring winding sections and a second spacing plate of the two spacing plates is arranged at a second end of a second winding section of the two neighboring winding sections, with the first end of the first winding section facing the second end of the second winding section; and
wherein each separation section further comprises a third bottom plate which is set on a plane orthogonal to the first direction and connects the two spacing plates between corresponding edges of the two spacing plates, and wherein for each separation section, the two spacing plates and the third bottom plate at least partly enclose the respective reception space, wherein the first direction is orthogonal to the principal direction of extent, and the plane does not intersect with the principal direction of extent.

6. The one-piece bobbin structure according to claim 4, wherein each ending section of the two ending sections comprises an ending plate that is orthogonal to the principal direction of extent and which ending plate comprises a ending hole, wherein the one-piece bobbin structure is embodied such that the through-hole passes through the two ending holes of the two ending sections.

7. The one-piece bobbin structure according to claim 6, wherein the two ending plates and all spacing plates of the N-1 separation sections have equal dimensions from a perspective of the principal direction of extent, and the two ending holes of the two ending plates and all middle holes of the N-1 separation sections are aligned with each other.

8. The one-piece bobbin structure according to claim 1, wherein the first ending section comprises a first part of a first snap-fitting mechanism, which is configured to interact with a first complementary part of the first snap-fitting mechanism to provide snap-fitting, and wherein the second ending section comprises a second part of a second snap-fitting mechanism, which is configured to interact with a second complementary part of the second snap-fitting mechanism to provide snap-fitting.

9. A bobbin structure arrangement comprising M one-piece bobbin structures according to claim 8, with M being a natural number equal to or greater than two, wherein all of the M one-piece bobbin structures have a same structure, and the respective principal directions are parallel to one another, wherein for any two neighboring one-piece bobbin structures of the M one-piece bobbin structures,
the first ending section of a first one-piece bobbin structure of the respective two neighboring one-piece bobbin structures comprises a first part of a first snap-fitting mechanism,
the first ending section of a second one-piece bobbin structure of the respective two neighboring one-piece bobbin structures comprises a first complementary part of the first snap-fitting mechanism,
the second ending section of the first one-piece bobbin structure of the respective two neighboring one-piece bobbin structures comprises a second part of a second snap-fitting mechanism, and
the second ending section of the second one-piece bobbin structure of the respective two neighboring one-piece bobbin structures comprises a second complementary part of the second snap-fitting mechanism,
wherein the respective two neighboring one-piece bobbin structures are snap-fitted to one another through interaction between the first part of the first snap-fitting mechanism and the first complementary part of the first snap-fitting mechanism and through interaction between the second part of the second snap-fitting mechanism and the second complementary part of the second snap-fitting mechanism.

10. The bobbin structure arrangement according to claim 9, wherein the N-1 separation sections of any one-piece bobbin structure of the M one-piece bobbin structures are bijectively related to the N-1 separation sections of any other one-piece bobbin structure of the M one-piece bobbin structures, wherein bijectively related separation sections of the M one-piece bobbin structures are arranged at substantially same positions with respect to the M parallel principal directions of extent, and wherein the bobbin structure arrangement at least partly encloses N-1 joint reception spaces, with each joint reception space of the N-1 joint reception spaces comprising the M reception spaces which are at least partly enclosed by bijectively related separation sections.

11. An integrated magnetic assembly, comprising
the one-piece bobbin structure according to claim 1,
the set of first soft-magnetic core elements, with the set of first soft-magnetic core elements having N-1 first soft-magnetic core elements, wherein each of the N-1 first soft-magnetic core elements is arranged in a corresponding reception space of the N-1 reception spaces of the one-piece bobbin structure,
the set of second soft-magnetic core elements, wherein in all of the N segments of the through-hole of the one-piece bobbin structure, at least one of the second soft-magnetic core elements is arranged, and
at least N windings being wound around the N winding sections of the one-piece bobbin structure,
wherein the N-1 first soft-magnetic core elements and the second soft-magnetic core elements are arranged such that for each of the N segments, a respective closed-loop magnetic path exists that passes at least through the at least one second soft-magnetic core element arranged in the respective segment, and through at least one of the N-1 first soft-magnetic core elements.

12. The integrated magnetic assembly according to claim 11, with N being equal to two and with the integrated magnetic assembly having a choke winding, a primary transformer winding and a secondary transformer winding, with the choke winding being wound around a first winding section of the two winding sections and with the primary transformer winding and the secondary transformer winding being wound around a second winding section of the two winding sections,
wherein the set of first soft-magnetic core elements comprises one I-core, the I-core having one yoke, and wherein the set of second soft-magnetic core elements comprises two E-cores, with each of the two E-cores having a yoke and three legs and with the three legs being parallel to one another, being arranged on one side of the yoke and being orthogonal to the yoke,
wherein the two E-cores are arranged such that a central leg of each E-core is arranged in a corresponding segment of the two segments of the through-hole, and the I-core and each of the two E-cores are dimensioned such that for each segment of the two segments a closed-loop magnetic path exists through the following magnetic core components: (i) the central leg in the respective segment, (ii) the I-core, (iii) an outer leg of the two outer legs of the E-core whose central leg is arranged in the respective segment, and (iv) the yoke of the E-core whose central leg is arranged in the respective segment.

13. The integrated magnetic assembly according to claim 11, with N being equal to two and with the integrated magnetic assembly having a first choke winding, a primary transformer winding and a secondary transformer winding, with the first choke winding being wound around a first winding section of the two winding sections and with the primary transformer winding and the secondary transformer winding being wound around a second winding section of the two winding sections,
wherein the set of first soft-magnetic core elements comprises one U-core having a yoke and two legs and with the two legs being parallel to each other, being arranged on one side of the yoke and being orthogonal to the yoke, wherein the yoke of the U-core is arranged in the one reception space of the one-piece bobbin structure;
wherein the set of second soft-magnetic core elements comprises two E-cores, with each of the two E-cores having a yoke and three legs and with the three legs being parallel to one another, being arranged on one side of the yoke and being orthogonal to the yoke, the two E-cores are arranged such that a central leg of each E-core is arranged in a corresponding segment of the two segments of the through-hole, and the two outer legs of a first E-core of the two E-cores abut the two outer legs of the U-core;
wherein the U-core and the two E-cores are dimensioned such that a first closed-loop magnetic path exists through the following magnetic core components: (i) the central leg of the first E-core, (ii) the yoke of the U-core, (iii) a first leg of the two legs of the U-core, (iv) the outer leg of the first E-core abutting the first leg of the two legs of the U-core, and (v) the yoke of the first E-core,
and such that a second closed-loop magnetic path exists through the following magnetic core components: (i) the central leg of a second E-core of the two E-cores, (ii) the yoke of the U-core, (iii) an outer leg of the two outer legs of the second E-core, and (iv) the yoke of the second E-core.

14. The integrated magnetic assembly according to claim 11, with N being equal to three and with the integrated magnetic assembly having a primary choke winding, a primary transformer winding, a secondary transformer winding and a secondary choke winding, with the primary choke winding being wound around a first winding section of the three winding sections, with the primary transformer winding and the secondary transformer winding being wound around a second winding section of the three winding sections and with the secondary choke winding being wound around a third winding section of the three winding sections,
wherein the set of first soft-magnetic core elements comprises two U-cores, each U-core having one yoke and two legs and with the two legs being parallel to one another, being arranged on one side of the yoke and being orthogonal to the yoke, wherein the two yokes of the two U-cores are respectively arranged in the two reception spaces, and the two legs of a first U-core of the two U-cores respectively abut the two legs of a second U-core of the two U-cores; and
wherein the set of second soft-magnetic core elements comprises two E-cores and a transformer core, with each of the two E-cores having a yoke and three legs and with the three legs being parallel to one another, being arranged on one side of the yoke and being orthogonal to the yoke, wherein the two E-cores are arranged such that a central leg of each E-core is arranged in a corresponding segment enclosed by the first winding section or the third winding section, and the transformer core is arranged in the segment enclosed by the second winding section.

15. An integrated magnetic assembly, comprising
the bobbin structure arrangement according to claim 10,
the set of first soft-magnetic core elements having N-1 soft-magnetic core elements, wherein each of the first soft-magnetic core elements is arranged in a corresponding joint reception space of the N-1 joint reception spaces of the bobbin structure arrangement,
the set of second soft-magnetic core elements, wherein in each segment of the M*N segments of the M through-holes of the bobbin structure arrangement, at least one of the second soft-magnetic core elements is arranged, and
at least M*N windings being wound around the M*N winding sections of the bobbin structure arrangement,
wherein the N-1 first soft-magnetic core elements and the second soft-magnetic core elements are arranged such that for each segment of the M*N segments, a respective closed-loop magnetic path exists that passes at least through the at least one of the second soft-magnetic core elements that is arranged in the respective segment, and through at least one of the N-1 soft-magnetic first core elements.

16. The integrated magnetic assembly according to claim 15, with N being equal to two and M being equal to two, with the integrated magnetic assembly having a first choke winding, a first primary transformer winding, a first secondary transformer winding, a second choke winding, a second primary transformer winding and a second secondary transformer winding, with the first choke winding being wound around one winding section of the two winding sections of a first one-piece bobbin structure of the bobbin structure arrangement, with the first primary transformer winding and the first secondary transformer winding being wound around the other winding section of the two winding sections of the first one-piece bobbin structure, with the second choke winding being wound around one winding section of the two winding sections of a second one-piece bobbin structure of the bobbin structure arrangement and with the second primary transformer winding and the second secondary transformer winding being wound around the other winding section of the two winding sections of the second one-piece bobbin structure,
wherein the set of first soft-magnetic core elements comprises one I-core having one yoke and arranged in the one joint reception space, and wherein the set of second soft-magnetic core elements comprises two U-cores, with each of the two U-cores having a yoke and two legs and with the two legs being parallel to each other, being arranged on one side of the yoke and being orthogonal to the yoke,
wherein the two U-cores are arranged such that the two legs of a first U-core of the two U-cores are arranged in the two segments enclosed by the two winding sections around which the first choke winding and respectively the second choke winding are wound, and wherein the two legs of a second U-core of the two U-cores are arranged in the two segments enclosed by the two winding sections around which the first primary transformer winding and the first secondary transformer winding and respectively the second primary transformer winding and the second secondary transformer winding are wound,
and wherein the two U-cores and the I-core are dimensioned such that (i) a first closed-loop magnetic path exists through the yoke of the first U-core, the two legs of the first U-core and the I-core, and such that (ii) a second closed-loop magnetic path exists through the yoke of the second U-core, the two legs of the second U-core and the I-core.

17. The integrated magnetic assembly according to claim 15, with N being equal to two and M being equal to three, with the integrated magnetic assembly having a first choke winding, a first primary transformer winding, a first secondary transformer winding, a second choke winding, a second primary transformer winding and a second secondary transformer winding, a third choke winding, a third primary transformer winding and a third secondary transformer winding, with the first choke winding being wound around one winding section of the two winding sections of a first one-piece bobbin structure of the bobbin structure arrangement, with the first primary transformer winding and the first secondary transformer winding being wound around the other winding section of the two winding sections of the first one-piece bobbin structure, with the second choke winding being wound around one winding section of the two winding sections of a second one-piece bobbin structure of the bobbin structure arrangement, with the second primary transformer winding and the second secondary transformer winding being wound around the other winding section of the two winding sections of the second one-piece bobbin structure, with the third choke winding being wound around one winding section of the two winding sections of a third one-piece bobbin structure of the bobbin structure arrangement and with the third primary transformer winding and the third secondary transformer winding being wound around the other winding section of the two winding sections of the third one-piece bobbin structure,
wherein the set of first soft-magnetic core elements comprises one I-core, the I-core having one yoke and arranged in the one joint reception space, and wherein the set of second soft-magnetic core elements comprises two E-cores, with each of the two E-cores having a yoke and three legs and with the three legs being parallel to one another, being arranged on one side of the yoke and being orthogonal to the yoke,
wherein the two E-cores are arranged such that the three legs of a first E-core of the two E-cores are arranged in the three segments enclosed by the three winding sections around which the first choke winding, the second choke winding and respectively the third choke winding are wound, and wherein the three legs of a second E-core of the two E-cores are arranged in the three segments enclosed by the three winding sections around which the first primary transformer winding and the first secondary transformer winding, the second primary transformer winding and the second secondary transformer winding and respectively the third primary transformer winding and the third secondary transformer winding are wound.

18. The integrated magnetic assembly according to claim 15, with N being equal to two and M being equal to two, with the integrated magnetic assembly having a first choke winding, a first primary transformer winding, a first secondary transformer winding, a second choke winding, a second primary transformer winding and a second secondary transformer winding, with the first choke winding being wound around one winding section of the two winding sections of a first one-piece bobbin structure of the bobbin structure arrangement, with the first primary transformer winding and the first secondary transformer winding being wound around the other winding section of the two winding sections of the first one-piece bobbin structure, with the second choke winding being wound around one winding section of the two winding sections of a second one-piece bobbin structure of the bobbin structure arrangement and with the second primary transformer winding and the second secondary transformer winding being wound around the other winding section of the two winding sections of the second one-piece bobbin structure,
wherein the set of first soft-magnetic core elements comprises one I-core having one yoke and arranged in the one joint reception space, and wherein the set of second soft-magnetic core elements comprises two E-cores, with each of the two E-cores having a yoke and three legs and with the three legs being parallel to each other, being arranged on one side of the yoke and being orthogonal to the yoke,
wherein the two E-cores are arranged such that the two outer legs of a first E-core of the two E-cores are arranged in the two segments enclosed by the two winding sections around which the first choke winding and respectively the second choke winding are wound, and wherein the two outer legs of a second E-core of the two E-cores are arranged in the two segments enclosed by the two winding sections around which the first primary transformer winding and the first secondary transformer winding and respectively the second primary transformer winding and the second secondary transformer winding are wound, and
wherein the two E-cores and the I-core are dimensioned such that (i) a first closed-loop magnetic path exists through the yoke of the first E-core, an outer leg of the first E-core, the I-core and a central leg of the first E-core, and such that (ii) a second closed-loop magnetic path exists through the yoke of the second E-core, an outer leg of the second E-core, the I-core and a central leg of the second E-core.

19. The integrated magnetic assembly according to claim 15, with N being equal to two and M being equal to three, with the integrated magnetic assembly having a first choke winding, a first primary transformer winding, a first secondary transformer winding, a second choke winding, a second primary transformer winding and a second secondary transformer winding, a third choke winding, a third primary transformer winding and a third secondary transformer winding, with the first choke winding being wound around one winding section of the two winding sections of a first one-piece bobbin structure of the bobbin structure arrangement, with the first primary transformer winding and the first secondary transformer winding being wound around the other winding section of the two winding sections of the first one-piece bobbin structure, with the second choke winding being wound around one winding section of the two winding sections of a second one-piece bobbin structure of the bobbin structure arrangement, with the second primary transformer winding and the second secondary transformer winding being wound around the other winding section of the two winding sections of the second one-piece bobbin structure, with the third choke winding being wound around one winding section of the two winding sections of a third one-piece bobbin structure of the bobbin structure arrangement and with the third primary transformer winding and the third secondary transformer winding being wound around the other winding section of the two winding sections of the third one-piece bobbin structure,
wherein the set of first soft-magnetic core elements comprises one I-core having one yoke and arranged in the one joint reception space, and wherein the set of second soft-magnetic core elements comprises two W-cores, with each of the two W-cores having a yoke and five legs and with the five legs being parallel to one another, being arranged on one side of the yoke and being orthogonal to the yoke,
wherein the two W-cores are arranged such that two outer legs and one central leg of a first W-core of the two W-cores are arranged in the three segments enclosed by the three winding sections around which the first choke winding, the second choke winding and respectively the third choke winding are wound, and wherein two outer legs and one central leg of a second W-core of the two W-cores are arranged in the three segments enclosed by the three winding sections around which the first primary transformer winding and the first secondary transformer winding respectively the second primary transformer winding and the second secondary transformer winding and respectively the third primary transformer winding and the third secondary transformer winding are wound.

20. The integrated magnetic assembly according to claim 15, with N being equal to three and M being equal to two, with the integrated magnetic assembly having a first primary choke winding, a first primary transformer winding, a first secondary transformer winding, a first secondary choke winding, a second primary choke winding, a second primary transformer winding, a second secondary transformer winding and a second secondary choke winding, with the first primary choke winding being wound around a first winding section of the three winding sections of a first one-piece bobbin structure of the bobbin structure arrangement, with the first primary transformer winding and the first secondary transformer winding being wound around a second winding section of the three winding sections of the first one-piece bobbin structure, with the first secondary choke winding being wound around a third winding section of the three winding sections of the first one-piece bobbin structure, with the second primary choke winding being wound around a first winding section of the three winding sections of a second one-piece bobbin structure of the bobbin structure arrangement, with the second primary transformer winding and the second secondary transformer winding being wound around a second winding section of the three winding sections of the second one-piece bobbin structure, and with the second secondary choke winding being wound around a third winding section of the three winding sections of the second one-piece bobbin structure,
wherein the set of first soft-magnetic core elements comprises two I-cores, each I-core having one yoke and arranged in the two joint reception spaces, and wherein the set of second soft-magnetic core elements comprises two U-cores and two transformer cores, with each of the two U-cores having a yoke and two legs and with the two legs being parallel to each other, being arranged on one side of the yoke and being orthogonal to the yoke,
wherein the two U-cores are arranged such that the two legs of a first U-core of the two U-cores are arranged in the two segments enclosed by the two winding sections around which the first primary choke winding and respectively the second primary choke winding are wound, and wherein the two legs of a second U-core of the two U-cores are arranged in the two segments enclosed by the two winding sections around which the first secondary choke winding respectively the second secondary choke winding are wound, and wherein the two transformer cores are arranged in the two segments enclosed by the two winding sections around which the first primary transformer winding and the first secondary transformer winding and respectively the second primary transformer winding and the second secondary transformer winding are wound.
